(19) United States
(12) Patent Application Publication
(10) Pub. No.: US 2026/0273516 A1
(43) Pub. Date: Sep. 17, 2026

(54) ENCAPSULATED CATALYST, METHOD OF PREPARATION, COMPOSITION AND METHODS INVOLVING HYDROSILYLATION

(71) Applicants: DOW SILICONES CORPORATION, Midland, MI (US); THE BOARD OF TRUSTEES OF THE UNIVERSITY OF ILLINOIS, Urbana, IL (US)

(72) Inventors: Matthew JELETIC, Midland, MI (US); Damien GUIRONNET, Urbana, IL (US); Susannah HADDOCK, Urbana, IL (US); Ericka BRUSKE, Urbana, IL (US); Alison WEITZEL, Urbana, IL (US)

(21) Appl. No.: 19/168,588

(22) PCT Filed: Apr. 3, 2024
(86) PCT No.: PCT/US2024/022794

§ 371 Date: Sep. 24, 2025

Related U.S. Application Data
(60) Provisional application No. 63/456,859, filed on Apr. 4, 2023.
(60) Provisional application No. 63/465,554, filed on May 11, 2023.
(60) Provisional application No. 63/616,661, filed on Dec. 31, 2023.

(51) Int. Cl. B01J 31/12; B01J 31/22

(52) U.S. Cl. CPC B01J 31/123; B01J 31/2226; B01J 2231/323; B01J 2531/0213; B01J 2531/828

(57) ABSTRACT

An encapsulated catalyst for hydrosilylation comprises platinum(0) and/or platinum (II). A polymer encapsulates the platinum(0) and/or platinum (II). The polymer comprises structural units, at least some of the structural units of the polymer include a pyridine moiety, and at least some of the platinum(0) and/or platinum (II) is/are bound to at least some of the pyridine moieties of the polymer. When the platinum of the encapsulated catalyst is platinum(0), the encapsulated catalyst comprises at least 500 equivalents of pyridine moieties relative to total platinum. Methods of preparing the encapsulated catalyst, and compositions including the same, are also disclosed.

### CROSS REFERENCE TO RELATED APPLICATIONS

This application claims priority to and all advantages of U.S. Application No. 63/456,859 filed on 4 Apr. 2023, U.S. Application No. 63/465,554 filed on 11 May 2023, and U.S. Application No. 63/616,661 filed on 31 Dec. 2023, the contents of which are incorporated herein by reference in their entireties.

### FIELD OF THE INVENTION

The present disclosure generally relates to an encapsulated catalyst and, more specifically, to an encapsulated catalyst for hydrosilylation and to a method for preparing the encapsulated catalyst. The present disclosure also relates to compositions including the encapsulated catalyst and related methods.

### BACKGROUND

Hydrosilylation reactions are generally known in the art and involve an addition reaction between silicon-bonded hydrogen and aliphatic unsaturation. Hydrosilylation reactions are utilized in various applications. For example, curable compositions often rely on hydrosilylation reactions for purposes of curing or crosslinking components thereof to give a cured product. Hydrosilylation reactions may also be utilized to prepare individual components or compounds, e.g. components for inclusion in curable compositions.

Hydrosilylation reactions are carried out in the presence of a catalyst, which is typically a platinum metal due to its excellent catalytic activity. Metal complexes can also be utilized to catalyze hydrosilylation reactions.

It is often desirable to selectively control catalytic activity of catalysts, particularly to extend shelf life and stability of curable compositions. For example, many conventional catalysts will initiate a hydrosilylation reaction at ambient conditions, including room temperature. There have been many attempts to selectively control catalytic activity of catalysts, such as by including hydrosilylation reaction inhibitors along with the encapsulated catalyst, and by encapsulating catalysts with plastics that melt at elevated temperatures. However, conventional techniques to selectively control catalytic activity of catalysts have deficiencies. For example, incomplete encapsulation reduces shelf life and stability. Further, though encapsulated catalysts can prevent premature reaction at ambient conditions, conventional encapsulated catalysts must be washed to remove residual catalyst. For example, residual catalyst remains on external surfaces of conventional encapsulated catalysts, which must be removed to prevent premature reaction, adding to processing steps and cost.

### BRIEF SUMMARY

This disclosure provides an encapsulated catalyst for hydrosilylation. The encapsulated catalyst comprises platinum(0) and/or platinum (II). A polymer encapsulates the platinum(0) and/or platinum (II). The polymer comprises structural units, at least some of the structural units of the polymer include a pyridine moiety, and at least some of the platinum(0) and/or platinum (II) is/are bound to at least some of the pyridine moieties of the polymer. When the platinum of the encapsulated catalyst is platinum(0), the encapsulated catalyst comprises at least 500 equivalents of pyridine moieties relative to total platinum.

A method of preparing an encapsulated catalyst for hydrosilylation is also disclosed. The method comprises combining platinum(0) and/or platinum (II) with a polymer. The method further comprises encapsulating the platinum(0) and/or platinum (II) with the polymer. The polymer comprises structural units, at least some of the structural units of the polymer include a pyridine moiety, and at least some of the platinum(0) and/or platinum (II) is/are bound to at least some of the pyridine moieties of the polymer. When the platinum of the encapsulated catalyst is platinum(0), the encapsulated catalyst comprises at least 500 equivalents of pyridine moieties relative to total platinum.

Further, this disclosure provides a composition. The composition comprises (A) an unsaturated compound including at least one aliphatically unsaturated group per molecule, subject to at least one of the following two provisos: (1) the unsaturated compound (A) also includes at least one silicon-bonded hydrogen atom per molecule; and/or (2) the composition further comprises (B) a silicon hydride compound including at least one silicon-bonded hydrogen atom per molecule. The composition further comprises the encapsulated catalyst.

A method of preparing a hydrosilylation reaction product is also provided. The method comprises reacting an aliphatically unsaturated group and a silicon-bonded hydrogen atom in the presence of the encapsulated catalyst to give the hydrosilylation reaction product. The aliphatically unsaturated group is present in the unsaturated compound (A), which is subject to the same provisos noted above in regards to the composition.

### DETAILED DESCRIPTION

The present disclosure provides an encapsulated catalyst. The encapsulated catalyst has excellent physical properties and catalytic activity in hydrosilylation reactions. The encapsulated catalyst has an exceptional shelf-life and longevity as compared to conventional catalysts for hydrosilylation, including conventional encapsulated catalysts. Moreover, the encapsulated catalyst need not be washed prior to use in catalyzing a hydrosilylation reaction, which is a significant benefit over conventional encapsulated catalysts, which often include residual transitional metals on external surfaces of encapsulation layers that must be removed. The encapsulated catalyst reduces processing steps associated with its preparation, provides longevity and stability in one-part compositions, and can be selectively activated at desired reaction temperatures.

The encapsulated catalyst comprises platinum(0) and/or platinum (II). As known in the art, platinum can have a number of oxidation states, with 0, +2 and +4 being the most common. The oxidation state of the platinum(0) and/or the platinum (II) is advantageous in the encapsulated catalyst because the platinum(0) and/or the platinum (II) binds to certain ligands present in the encapsulated catalyst, as described below.

Platinum(0) and the platinum (II) are known in the art and commercially available. Typically, the platinum(0) and/or the platinum (II) is present in the encapsulated catalyst in the form of individual atoms rather than as clustered particles, as readily understood in the art in the context of metal complexes. Typically, the source of the platinum(0) and/or the platinum (II) in the encapsulated catalyst is a platinum complex that includes ligands that are dissociate from the platinum complex when preparing the encapsulated complex, as described in greater detail below with regard to the method of preparing the encapsulated catalyst. However, the source of the platinum(0) and/or the platinum (II) is not limited

The encapsulated catalyst can comprise only platinum(0), only platinum (II), or both platinum(0) and platinum (II)

The encapsulated catalyst further comprises a polymer encapsulating the platinum(0) and/or platinum (II). The polymer comprises structural units, at least some of the structural units of the polymer include a pyridine moiety. The polymer is not limited so long as it includes at least some structural units including a pyridine moiety. For example, the polymer may be a homopolymer (i.e., comprise only structural units including a pyridine moiety), or a copolymer (i.e., comprise two or more different types of structural units, which may be in block form, randomized, repeating, etc.).

For purposes of this disclosure, “encapsulated” is meant to encompass any form of the inventive catalyst whereby the platinum(0) and/or platinum (II) is bound in/to the polymer. Said differently, the encapsulated catalyst need not take the form (and generally does not take the form) of a core of platinum(0) and/or platinum (II) surrounded by layer or shell of the polymer as an encapsulant. Instead, as described below, the encapsulated catalyst need not be in the form of a particle, and can be a disposed in a carrier vehicle or solvent.

The structural units of the polymer which include pyridine moieties can be independently selected and independently derived. Such structural units can be derived from any monomers that include a pyridine moiety and which can be polymerized (alone or with other monomers) to give the polymer having structural units including pyridine moieties. In specific embodiments, the structural units of the polymer having pyridine moieties are derived from vinylpyridine. The vinylpyridine can be, for example, 2-vinylpyridine, 3-vinylpyridine, 4-vinylpyridne, etc., or combinations of different vinylpyridines. In specific embodiments, the structural units of the polymer having pyridine moieties are derived from 4-vinyl pyridine.

In certain embodiments, the polymer is a homopolymer of vinylpyridine. In specific embodiments, the polymer is a homopolymer of 4-vinylpyridine.

In other embodiments, the polymer comprises structural units other than those including a pyridine moiety. These structural units can be independently selected and can be formed from the same or different monomers. In one embodiment t, the other structural units of the polymer are those utilized to prepare acrylic or acrylate polymers.

Methods of preparing acrylic polymers are known in the art. For example, acrylic polymers may be prepared via a conventional radical polymerization of acrylic monomers. Such conventional methods are generally carried out by combining radically-polymerizable monomers (e.g. acrylate monomers, comonomers, etc.) in the presence of a radical initiator/generator, such as a thermo-, chemo, and/or photopolymerization initiator. For example, peroxides and aromatic initiators (e.g. phenols, benzoins, heterocylcles such as imidazoles, etc.) are commonly utilized. These conventional methods may be used to prepare acrylate homopolymers and copolymers, including ternary, quaternary, and higher-order copolymers. Acrylic monomers bearing other functional groups can be copolymerized to introduce these functional groups onto the polyacrylate chain. These monomers include, for example, hydroxyl functional monomers. These functionalities can also be converted after polymerization into functional groups desirable for certain end use applications. For example, an anhydride group can be readily transformed to an acid by hydrolysis, or a hydroxyl by reacting with a polyhydric hydroxyl compound. Unsaturation of different reactivity towards initiated polymerization can be used to introduce side functional unsaturated groups such as allyl, for example. Various controlled free radical polymerization techniques can be utilized to prepare more defined polyacrylate structures bearing functional groups at the more exact locations desired. These techniques include, but are not limited to, the techniques of reversible-deactivation polymerization, catalytic chain transfer and cobalt mediated radical polymerization, iniferter polymerization, stable free radical mediated polymerization, atom transfer radical polymerization (ATRP), reversible addition fragmentation chain transfer polymerization (RAFT), iodine-transfer polymerization (ITP), selenium-centered radical mediated polymerization, telluride mediated polymerization (TERP), stibine-mediated polymerization, nitroxide-mediated polymerization, etc. Different acrylate monomers can be copolymerized to have a block or more random structure. Monomers other than acrylic monomers, such as styrene, can also be copolymerized. Functional groups can be introduced by end capping the living ends of the polymer at the end of the polymerization. Block copolymers can also be prepared by way of using macro-initiators. Acrylic polymers can also be prepared by anionic or cationic polymerization techniques. Additionally, di- and/or multifunctional acrylic monomers may also be utilized, e.g. to prepare multifunctional acrylic polymers, as will be understood in view of the description of suitable acrylic monomers herein.

Examples of specific monofunctional acrylic monomers suitable for preparing the polymer include (alkyl) acrylic compounds, such as methyl acrylate, phenoxyethyl (meth)acrylate, phenoxy-2-methylethyl (meth)acrylate, phenoxyethoxyethyl (meth)acrylate, 3-phenoxy-2-hydroxypropyl (meth)acrylate, 2-phenylphenoxyethyl (meth)acrylate, 4-phenylphenoxyethyl (meth)acrylate, 3-(2-phenylphenyl)-2-hydroxypropyl (meth)acrylate, polyoxyethylene-modified p-cumylphenol (meth)acrylate, 2-bromophenoxyethyl (meth)acrylate, 2,4-dibromophenoxyethyl (meth)acrylate, 2,4,6-tribromophenoxyethyl (meth)acrylate, polyoxyethylene-modified phenoxy (meth)acrylate, polyoxypropylene-modified phenoxy (meth)acrylate, polyoxyethylene nonylphenyl ether (meth)acrylate, isobornyl (meth)acrylate, 1-adamantyl (meth)acrylate, 2-methyl-2-adamantyl (meth)acrylate, 2-ethyl-2-adamantyl (meth)acrylate, bornyl (meth)acrylate, tricyclodecanyl (meth)acrylate, dicyclopentanyl (meth)acrylate, dicyclopentenyl (meth)acrylate, cyclohexyl (meth)acrylate, 4-butylcyclohexyl (meth)acrylate, acryloylmorpholine, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, benzyl (meth)acrylate, 1-naphthylmethyl (meth)acrylate, 2-naphthylmethyl (meth)acrylate, tetrahydrofurfuryl (meth)acrylate, butoxyethyl (meth)acrylate, ethoxydiethylene glycol (meth)acrylate, poly(ethylene glycol) mono(meth)acrylate, poly(propylene glycol) mono(meth)acrylate, methoxyethylene glycol (meth)acrylate, ethoxyethyl (meth)acrylate, methoxypoly(ethylene glycol) (meth)acrylate, methoxypoly(propylene glycol) (meth)acrylate, diacetone (meth)acrylamide, isobutoxymethyl (meth)acrylamide, N,N-dimethyl (meth)acrylamide, t-octyl (meth)acrylamide, dimethylaminoethyl (meth)acrylate, diethylaminoethyl (meth)acrylate, 7-amino-3,7-dimethyloctyl (meth)acrylate, N,N-diethyl (meth)acrylamide, N,N-dimethylaminopropyl (meth)acrylamide, and the like, as well as derivatives thereof.

Examples of specific polyfunctional acrylic monomers suitable for preparing the polymer include (alkyl) acrylic compounds having two or more acryloyl or methacryloyl groups, such as trimethylolpropane di(meth)acrylate, trimethylolpropane tri(meth)acrylate, polyoxyethylene-modified trimethylolpropane tri(meth)acrylate, polyoxypropylene-modified trimethylolpropane tri (meth)acrylate, polyoxyethylene/polyoxypropylene-modified trimethylolpropane tri (meth)acrylate, dimethyloltricyclodecane di(meth)acrylate, pentaerythritol tri(meth)acrylate, pentaerythritol tetra(meth)acrylate, ethylene glycol di(meth)acrylate, tetraethylene glycol di (meth)acrylate, phenylethylene glycol di(meth)acrylate, poly(ethylene glycol) di(meth)acrylate, poly(propylene glycol) di(meth)acrylate, 1,4-butanediol di(meth)acrylate, 1,6-hexanediol di (meth)acrylate, neopentyl glycol di(meth)acrylate, 1,9-nonanediol di(meth)acrylate, 1,10-decanediol di(meth)acrylate, 1,3-adamantanedimethanol di(meth)acrylate, o-xylylene di (meth)acrylate, m-xylylene di(meth)acrylate, p-xylylene di(meth)acrylate, tris(2-hydroxyethyl) isocyanurate tri(meth)acrylate, tris (acryloyloxy) isocyanurate, bis(hydroxymethyl)tricyclodecane di(meth)acrylate, dipentaerythritol penta(meth)acrylate, dipentaerythritol hexa(meth)acrylate, polyoxyethylene-modified 2,2-bis(4-((meth)acryloxy)phenyl) propane, polyoxypropylene-modified 2,2-bis(4-((meth)acryloxy)phenyl) propane, and polyoxyethylene/polyoxypropylene-modified 2,2-bis(4-((meth)acryloxy)phenyl) propane.

It is to be appreciated that the (alkyl) acrylic compounds above are described in terms of (meth)acrylate species only for brevity, and that one of skill in the art will readily understand that other alkyl and/or hydrido versions of such compounds may equally be utilized. For example, one of skill in the art will understand that the monomer “2-ethylhexyl (meth)acrylate” listed above exemplifies both 2-ethylhexyl (meth)acrylate as well as 2-ethylhexyl acrylate. Likewise, while the acrylic monomers are described generally as propenoates (i.e., α,β-unsaturated esters) in the examples above, it is to be appreciated that the that the term “acrylate” used in these descriptions may equally refer to an acid, salt, and/or conjugate base of the esters exemplified. For example, one of skill in the art will understand that the monomer “methyl acrylate” listed above exemplifies the methyl ester of acrylic acid, as well as acrylic acid, acrylate salts (e.g. sodium acrylate), etc. Furthermore, multifunctional derivatives/variations of the acrylic monomers described above may also be utilized. For example, the monomers “ethyl (meth)acrylate” listed above exemplifies functionalized-derivatives, such as substituted ethyl (meth)acrylates and ethyl acrylates (e.g. hydroxyethyl (meth)acrylate and hydroxyethyl acrylate, respectively).

Other monomers (i.e., monomers reactive with the acrylic monomers above) may also be utilized to prepare the polymer, either in combination with or in lieu of the monomers described above. Such monomers are not limited, and generally include compounds having a radically polymerizable group, such as an alkenyl, acryloyl, and alkylacryloyl groups. In general, such other monomers are selected by one of skill the in art, e.g. to alter a property of the polymer to be prepared. For example, it is known in the art that styrene may be copolymerized with an acrylic monomer to prepare a polymer having increased hardness as compared to those absent such styrene comonomers. Likewise, comonomers such as acrylonitrile may be utilized to increase interchain polar interactions, and thus increase tensile strength and ultimate toughness of acrylic polymers, while also decreasing low temperature flexibility of such acrylic polymers. Moreover, one of skill in the art will readily selected the proportion(s) of monomers utilized, the order of addition, the length of reaction, and other factors to independently tune various properties (e.g. flexibility, solubility, hardness, polarity, glass transition temperature, viscosity, etc.) of the polymer.

Specific examples of suitable other monomers include styrene, acrylonitrile, vinylidene chloride, vinylidene fluoride, vinyl acetate, vinyl chloride, ethylene, propylene, butylene, chloroprene, isoprene, tetrafluoroethylene, and the like, as well as derivatives thereof.

In certain embodiments, the polymer is formed with, and has structural units derived from, an acryloxy-functional organosilicon monomer.

The acryloxy-functional organosilicon monomer may be prepared or otherwise obtained, i.e., as a prepared compound. Methods of preparing the acryloxy-functional organosilicon monomer are known in the art, with such compounds and suitable starting materials commercially available from various suppliers.

The acryloxy-functional organosilicon monomer may have the general formula:

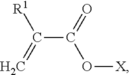

where R¹ is an alkyl group or H, and X comprises a siloxy moiety.

Typically, the siloxy moiety X includes a divalent linking group resent between the oxygen atom adjacent the siloxy moiety X and a silicon atom of the siloxy moiety X. For example, X may be of formula-D-Y, where D is a divalent linking group and Y is a siloxy moiety. When D is the divalent linking group, D is typically a saturated hydrocarbon group having from 2 to 10, alternatively from 2 to 8, alternatively from 2 to 6, alternatively from 2 to 4, carbon atoms. For example, when D is a propylene group, the acryloxy-functional organosilicon monomer has the following general formula:

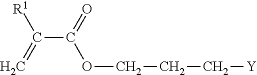

where R¹ and Y are as defined and described above.

With regard to the preceding formulae of the acryloxy-functional organosilicon monomer, the siloxy moiety Y (and the siloxy moiety X) typically has from 1 to 10, alternatively from 1 to 9, alternatively from 1 to 8, alternatively from 1 to 7, alternatively from 1 to 6, carbon atoms. In a specific embodiment, the siloxy moiety Y has the formula —Si(R²)(OSi(R²)₃)₂, where each R² is an independently selected substituted or unsubstituted hydrocarbyl group.

Each R² is independently selected, as introduced above, and may be linear, branched, cyclic, or combinations thereof. In general, hydrocarbyl groups suitable for R² may independently be linear, branched, cyclic, or combinations thereof. Cyclic hydrocarbyl groups encompass aryl groups as well as saturated or non-conjugated cyclic groups. Cyclic hydrocarbyl groups may independently be monocyclic or polycyclic. Linear and branched hydrocarbyl groups may independently be saturated or unsaturated. One example of a combination of a linear and cyclic hydrocarbyl group is an aralkyl group. General examples of hydrocarbyl groups include alkyl groups, aryl groups, alkenyl groups, halocarbon groups, and the like, as well as derivatives, modifications, and combinations thereof. Examples of suitable alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, hexadecyl, octadecyl, as well as branched saturated hydrocarbon groups having from 6 to 18 carbon atoms. Examples of suitable non-conjugated cyclic groups include cyclobutyl, cyclohexyl, and cycyloheptyl groups. Examples of suitable aryl groups include phenyl, tolyl, xylyl, naphthyl, benzyl, and dimethyl phenyl. Examples of suitable alkenyl groups include vinyl, allyl, propenyl, isopropenyl, butenyl, isobutenyl, pentenyl, heptenyl, hexenyl, hexadecenyl, octadecenyl and cyclohexenyl groups. Examples of suitable monovalent halogenated hydrocarbon groups (i.e., halocarbon groups, or substituted hydrocarbon groups) include halogenated alkyl groups, aryl groups, and combinations thereof. Examples of halogenated alkyl groups include the alkyl groups described above where one or more hydrogen atoms is replaced with a halogen atom such as F or Cl. Specific examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl, chloromethyl, chloropropyl, 2-dichlorocyclopropyl, and 2,3-dichlorocyclopentyl groups, as well as derivatives thereof. Examples of halogenated aryl groups include the aryl groups described above where one or more hydrogen atoms is replaced with a halogen atom, such as F or Cl. Specific examples of halogenated aryl groups include chlorobenzyl and fluorobenzyl groups.

In one embodiment, each R² is an alkyl group having from 1 to 4, alternatively 1 to 3, alternatively 1 or 2, alternatively 1, carbon atom. When each R² is methyl, Y has the formula:

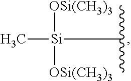

and when D is propylene in such embodiments, then the acryloxy-functional organosilicon monomer has the following structure:

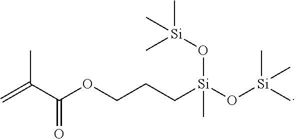 [SMILES: C=C(C)C(=O)OCCC[Si](C)(O[Si](C)(C)C)O[Si](C)(C)C]

With regard to the preceding formulae of the acryloxy-functional organosilicon monomer, R¹ is H or CH₃. In certain embodiments, R¹ is H (i.e., the acryloxy-functional organosilicon monomer comprises an acryloxy group). In other embodiments, R¹ is CH₃ such that the acryloxy-functional organosilicon component (A) comprises a (meth)acryloxy-functional organosilicon monomer (i.e., the acryloxy-functional organosilicon monomer is further defined as (meth)acryloxy-functional). In both instances, as will be understood by those of skill in the art, the term acryloxy-functional may be used to denote a genus encompassing both unsubstituted acryloxy functionality (e.g., where R¹ is H) as well as methyl-substituted acryloxy functionality (e.g., where R¹ is CH₃), just as the term “acrylate” is conventionally understood to encompass acrylic esters, (meth)acrylic esters, etc.

The acryloxy-functional organosilicon monomer may be prepared or otherwise obtained, i.e., as a prepared compound. Methods of preparing the acryloxy-functional organosilicon monomer are known in the art, with such compounds and suitable starting materials commercially available from various suppliers.

In one embodiment, the polymer comprises structural units derived from 4-vinylpyridine and a (meth)acrylate monomer, such as butyl acrylate. In other embodiments, the polymer comprises structural units derived from 4-vinylpyridine and styrene. In yet other embodiments, the polymer comprises structural units derived from 4-vinylpyridine and an acryloxy-functional organosilicon monomer.

The monomers utilized to prepare the polymer may be utilized in any amount or ratio, so long as the resulting acrylic polymer includes structural units including pyridine moieties. Monomers, as used herein, refer to the vinylpyridine and other optional monomers utilized to prepare the polymer. One of skill in the art can readily determine the particular monomers utilized and their amounts, e.g. dependent upon the particular components selected for reacting, the reaction parameters employed, the desired melting point temperature, etc.

Likewise, the monomers may be utilized in any form, such as neat (i.e., absent solvents, carrier vehicles, diluents, etc.), or disposed in a carrier vehicle, such as a solvent or dispersant. For example, the monomers may be disposed in a carrier vehicle, such as one of those described herein, as described in further detail below with regard to the method of preparing the encapsulated catalyst.

In the encapsulated catalyst, at least some of the platinum(0) and/or platinum (II) is/are bound to at least some of the pyridine moieties of the polymer. For example, the pyridine moieties of the polymer serve as ligands the platinum(0) and/or platinum (II) so that the platinum(0) and/or platinum (II) is bound in/to the polymer itself. The inventive encapsulated catalyst provides significant benefits over conventional encapsulated catalysts where platinum is simply physically entrapped within a polymer matrix, typically a polyolefin, in the absence of binding ligands in the polyolefin itself.

In one embodiment, the platinum of the encapsulated catalyst comprises, alternatively is, platinum(0). When the platinum of the encapsulated catalyst is platinum(0), the encapsulated catalyst comprises at least 500, alternatively at least 550, alternatively at least 600, alternatively at least 650, alternatively at least 700, alternatively at least 750, alternatively at least 800, alternatively at least 850, alternatively at least 900, alternatively at least 950, alternatively at least 1000, alternatively at least 1050, alternatively at least 1100, alternatively at least 1150, alternatively at least 1200, alternatively at least 1250, equivalents of pyridine moieties relative to total platinum content. The equivalents of pyridine moieties relative to total platinum ensure proper binding of the platinum to the pyridine moieties and performance of the encapsulated catalyst. When the platinum of the encapsulated catalyst is platinum (II), the proviso does not apply.

One of skill in the art understands how the proviso relating to equivalents of pyridine moieties relative to total platinum when the platinum is platinum(0) influences the polymer. For example, if the polymer is not a homopolymer and includes other structural units not including a pyridine moiety, than the relative amounts of monomers that do not have pyridine groups are selected to ensure that the polymer and resulting encapsulated catalyst have the desired equivalents of pyridine moieties relative to total platinum.

The encapsulated catalyst may optionally be disposed in a vehicle, e.g. a solvent which solubilizes the encapsulated catalyst, alternatively a vehicle which merely carries or disperses, but does not solubilize, the encapsulated catalyst. Such vehicles are known in the art.

Suitable vehicles include silicones, both linear and cyclic, organic oils, organic solvents and mixtures of these. For example, relative to silicones, the carrier vehicle may comprise a polydialkylsiloxane, e.g. polydimethylsiloxane.

The vehicle may also be a low viscosity organopolysiloxane or a volatile methyl siloxane or a volatile ethyl siloxane or a volatile methyl ethyl siloxane having a viscosity at 25° C. in the range of 1 to 1,000 mm²/sec, such as hexamethylcyclotrisiloxane, octamethylcyclotetrasiloxane, decamethylcyclopentasiloxane, dodecamethylcyclohexasiloxane, octamethyltrisiloxane, tetradecamethylhexasiloxane, decamethyltetrasiloxane, dodecamethylpentasiloxane, hexadeamethylheptasiloxane, heptamethyl-3-{(trimethylsilyl)oxy)}trisiloxane, hexamethyl-3,3, bis{(trimethylsilyl)oxy}trisiloxane pentamethyl{(trimethylsilyl)oxy}cyclotrisiloxane as well as polydimethylsiloxanes, polyethylsiloxanes, polymethylethylsiloxanes, polymethylphenylsiloxanes, polydiphenylsiloxanes, caprylyl methicone, and any mixtures thereof.

Alternatively, the vehicle may comprise an organic solvent. Examples of organic solvents include: aromatic hydrocarbons, such as benzene, toluene, xylene, mesitylene, etc.; aliphatic hydrocarbons, such as heptane, hexane, octane, etc.; glycol ethers, such as propylene glycol methyl ether, dipropylene glycol methyl ether, propylene glycol n-butyl ether, propylene glycol n-propyl ether, ethylene glycol n-butyl ether, etc.; halogenated hydrocarbons, such as dichloromethane, 1,1,1-trichloroethane, and chloroform; ketones, such as acetone, methylethyl ketone, or methyl isobutyl ketone; acetates, such as ethyl acetate, butyl acetate, ethylene glycol monoethyl ether acetate, and propylene glycol methyl ether acetate; alcohols, such as methanol, ethanol, isopropanol, butanol, or n-propanol; and others organic compounds that present as liquid/fluid at typical reaction temperatures, such as dimethyl sulfoxide, dimethyl formamide, acetonitrile, tetrahydrofuran, white spirits, mineral spirits, naphtha, n-methylpyrrolidone; and the like, as well as derivatives, modifications, and combination thereof.

The present invention further provides a method of preparing the encapsulated catalyst. The method comprises combining platinum(0) and/or platinum (II) with a polymer. The method further comprises encapsulating the platinum(0) and/or platinum (II) with the polymer. The polymer is described above with respect to the encapsulated catalyst.

Typically, the polymer is prepared in a first carrier vehicle, such as any of the carrier vehicles described immediately above, and the platinum(0) and/or platinum (II) are combined with the polymer for encapsulation in a second carrier vehicle, which may also be any of the carrier vehicles described above. In one embodiment, the first carrier vehicle is different from the second carrier vehicle, e.g. the polymer may be removed from the first carrier vehicle and combined with the platinum(0) and/or platinum (II) in the second carrier vehicle.

For example, in one embodiment, the monomers selected to prepare the polymer are disposed in an organic solvent, such as toluene, and polymerized to give the polymer. The monomers are polymerized in the presence of an initiator. The particular type or specific compound(s) selected for use in or as the initiator will be readily selected by those of skill in the art based on the monomers selected, any carrier vehicle present in the reaction, if any, etc. In general, the initiator is not particularly limited, and may comprise or be any compound suitable for facilitating the polymerization of the alkenyl functionality of the various monomer utilized (e.g. via radical polymerization, radical coupling, etc.), as will be understood by one of skill in the art in view of the description herein. As such, the initiator is typically a radical polymerization initiator, such as any of those conventionally used in polymerization of vinyl-functional compounds.

Examples of initiators include various peroxides, such as inorganic peroxides (e.g. hydrogen peroxide derivatives of potassium persulfate, sodium persulfate, ammonium persulfate, etc.) and various organic peroxides including benzoyl peroxide, t-butylperoxy maleic acid, succinic acid peroxides, t-butyl hydroperoxide, tert-butyl peroxypivalate (tBPPiv), etc. Additional examples of initiators include compounds that generates a free radical upon exposure to a reaction condition, e.g. when exited by a certain type of energy source (e.g. heat, UV light, etc.) etc. Examples of such compounds include (2,2,6,6-Tetramethylpiperidin-1-yl)oxyl (TEMPO), triazines, thiazines such as 10-phenylphenothiazine, 9,9′-bixanthene-9,9′-diol, 2,2-dimethoxy-2-phenylacetophenone, peroxides such as 2,5-dimethyl-2,5-di-(tert-butylperoxy) hexane (DBPH), and the like, as well as derivatives, modifications, and combinations thereof. In some embodiments, the initiator may comprise or be a photoactivatable catalyst, which may initiate polymerization via irradiation and/or heat (e.g. upon exposure to radiation having a wavelength of from 150 to 800 nanometers (nm), etc.). In one embodiment, the initiator comprises azobisisobutyronitrile (AIBN).

The initiator may be utilized in any amount, which will be selected by one of skill in the art, e.g. dependent upon the particular initiator selected (e.g. the concentration/amount of active components thereof, the type of catalyst being utilized, etc.), the reaction parameters employed, the scale of the reaction, etc. The molar ratio of the initiator to the monomers utilized in the reaction may influence the rate and/or amount of polymerization to prepare the polymer. Thus, the amount of the initiator as compared to the monomers, as well as the molar ratios therebetween, may vary.

In certain embodiments, the initiator is utilized in the reaction in an amount of from 0.01 to 20 wt. %, based on the total amount of monomers utilized (i.e., wt./wt.). It is also to be appreciated that the initiator may itself comprise more than one type of initiator compound, such as two, three, or more different initiator compounds, which may be individually selected.

In certain embodiments, combining platinum(0) and/or platinum (II) with the polymer comprises combining a platinum(0) complex and/or platinum (II) complex with the polymer. As understood in the art, when the platinum(0) and/or platinum (II) is in the form of a metal complex, the platinum(0) and/or platinum (II) includes ligands bound thereto. Such platinum(0) complexes and platinum (II) complexes are known in the art and can be obtained or otherwise synthesized.

In specific embodiments, a platinum(0) complex is utilized in the method to prepare the encapsulated catalyst. Typically, the platinum(0) complex is capable of being solvated in an organic solvent, i.e., capable of solubilizing, or at least partially solubilizing, in an organic solvent. Examples of suitable organic solvents are described above with respect to vehicles for the encapsulated catalyst. One specific example of such a platinum(0) complex that is capable of being solvated in an organic solvent is Karstedt's catalyst, i.e., a platinum(0)-1,3-divinyl-1,1,3,3-tetramethyldisiloxane complex. In such embodiments, the platinum(0)-1,3-divinyl-1,1,3,3-tetramethyldisiloxane complex is typically solubilized in an organic solvent, often toluene. A platinum(0)-1,3-divinyl-1,1,3,3-tetramethyldisiloxane complex has the following structure:

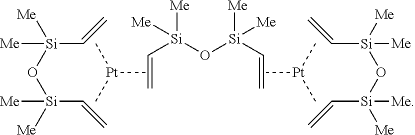

In these or other embodiments, a platinum (II) complex is utilized in the method to prepare the encapsulated catalyst. Typically, the platinum (II) complex is capable of being solvated in an organic solvent, i.e., capable of solubilizing, or at least partially solubilizing, in an organic solvent. Examples of suitable organic solvents are described above with respect to vehicles for the encapsulated catalyst. One specific example of such a platinum (II) complex that is capable of being solvated in an organic solvent is the following:

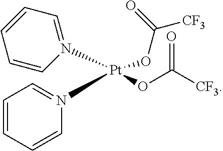

The platinum (II) complex immediately above can be synthesized, for example, by reacting (Py)₂Ptl₂ and silver trifluoroacetate.

Combining the platinum(0) complex and/or platinum (II) complex with the polymer typically results in ligand exchange, whereby the platinum of the platinum(0) complex and/or the platinum of the platinum (II) complex binds to the pyridine moieties of the polymer. Such ligand exchange results in the encapsulated catalyst.

In one embodiment, the step of combining platinum(0) and/or platinum (II) with the polymer is carried out in an alcohol, e.g. ethanol. In these embodiments, the polymer is disposed in the alcohol prior to combining the platinum(0) and/or platinum (II) and the polymer. In certain embodiments, a second carrier vehicle is utilized after the step of combining platinum(0) and/or platinum (II) with the polymer. For example, in certain embodiments, a silicon fluid, such as polydimethylsiloxane, is combined along with the alcohol when preparing the encapsulated catalyst.

In one embodiment, the platinum of the encapsulated catalyst comprises, alternatively is, platinum(0). When the platinum of the encapsulated catalyst is platinum(0), the encapsulated catalyst comprises at least 500, alternatively at least 550, alternatively at least 600, alternatively at least 650, alternatively at least 700, alternatively at least 750, alternatively at least 800, alternatively at least 850, alternatively at least 900, alternatively at least 950, alternatively at least 1000, alternatively at least 1050, alternatively at least 1100, alternatively at least 1150, alternatively at least 1200, alternatively at least 1250, equivalents of pyridine moieties relative to total platinum content. The equivalents of pyridine moieties relative to total platinum ensure proper binding of the platinum to the pyridine moieties and performance of the encapsulated catalyst. When the platinum of the encapsulated catalyst is platinum (II), the proviso does not apply. When the encapsulated catalyst is platinum (II), the equivalents of pyridine moieties relative to total platinum content is selected based on the desired catalytic/inhibitive properties of the encapsulated catalyst. Increasing the equivalents of pyridine moieties relative to total platinum content increases inhibitive properties for the same temperature.

The molar ratio of pyridine moieties to total platinum in the encapsulated catalyst generally influences catalytic vs. inhibitive properties of the encapsulated catalyst at specific temperatures. As such, the molar ratio of pyridine moieties to total platinum in the encapsulated catalyst is generally selected based on end use applications of the encapsulated catalyst, and desired parameters for using the encapsulated catalyst in a hydrosilylation reaction, as described below. In certain embodiments, it can be desirable to inhibit the hydrosilylation reaction at room temperature to improve shelf life and stability, particularly of one-part compositions, with catalytic activity being triggered at elevated temperatures.

For example, the encapsulated catalyst may inhibit a hydrosilylation reaction at room temperature, but readily catalyze a hydrosilylation reaction at an elevated temperature, e.g. 70° C.

Increasing the equivalents of pyridine moieties relative to total platinum generally increases stability of compositions including the encapsulated catalyst including at elevated temperatures. For example, the encapsulated catalyst has little to no catalytic effect at room temperature. However, based on an end use of the encapsulated catalyst, one of skill in the art can determine or selectively control an activation temperature of the encapsulated catalyst based on the equivalents of pyridine moieties relative to total platinum. As an example, the encapsulated catalyst may readily catalyze hydrosilylation at 80° C. at 500 equivalents of pyridine moieties relative to total platinum, but substantially prevent hydrosilylation at 80° C. at 1000 equivalents of pyridine moieties relative to total platinum. Thus, the encapsulated catalyst is “tunable” based on control of the equivalents of pyridine moieties relative to total platinum and desired properties of the encapsulated catalyst. As understood by one of skill in the art, tunability is a function of many factors, including the particular species of encapsulated catalyst utilize, including the oxidation state of the platinum.

Encapsulating the platinum(0) and/or platinum (II) can be carried out via any suitable technique, optionally while modifying or selectively controlling ambient conditions, such as temperature, etc.

In certain embodiments, the method of preparing the encapsulated catalyst is free from the step of washing the encapsulated catalyst. In these embodiments, the encapsulated catalyst is not washed prior to use in a hydrosilylation reaction. Conventional encapsulated catalysts generally requiring washing to remove residual metal atoms from an external surface of the encapsulant, which physically entrains the metal atoms. However, because the platinum is bound to pyridine moieties in the inventive encapsulated catalyst, washing is not required, which reduces processing steps and cost.

As introduced above, the present invention also provides a composition. The composition comprises (A) an unsaturated compound. The unsaturated compound (A) includes at least one aliphatically unsaturated group per molecule, which may alternatively be referred to as ethylenic unsaturation. The unsaturated compound (A) is not limited and may be any unsaturated compound having at least one aliphatically unsaturated group. In certain embodiments, the unsaturated compound (A) comprises an organic compound. In other embodiments, the unsaturated compound (A) comprises a siloxane. In yet other embodiments, the unsaturated compound (A) comprises a silicone-organic hybrid, or an organosilicon compound. Various embodiments and examples of the unsaturated compound (A) are disclosed below.

In certain embodiments, the unsaturated compound (A) includes an average of at least two aliphatically unsaturated groups per molecule. In such embodiments, the unsaturated compound (A) is capable of polymerization or curing beyond single cure-site hydrosilylation. The aliphatically unsaturated groups of the unsaturated compound (A) may be terminal, pendent, or in both locations in the unsaturated compound (A).

For example, the aliphatically unsaturated group may be an alkenyl group and/or an alkynyl group. “Alkenyl group” means an acyclic, branched or unbranched, monovalent hydrocarbon group having one or more carbon-carbon double bonds. The alkenyl group may have from 2 to 30 carbon atoms, alternatively from 2 to 24 carbon atoms, alternatively from 2 to 20 carbon atoms, alternatively from 2 to 12 carbon atoms, alternatively from 2 to 10 carbon atoms, alternatively from 2 to 6 carbon atoms. Alkenyl groups are exemplified by, but not limited to, vinyl, allyl, propenyl, and hexenyl. “Alkynyl group” means an acyclic, branched or unbranched, monovalent hydrocarbon group having one or more carbon-carbon triple bonds. The alkynyl group may have from 2 to 30 carbon atoms, alternatively from 2 to 24 carbon atoms, alternatively from 2 to 20 carbon atoms, alternatively from 2 to 12 carbon atoms, alternatively from 2 to 10 carbon atoms, alternatively from 2 to 6 carbon atoms. Alkynyl is exemplified by, but not limited to, ethynyl, propynyl, and butynyl.

In specific embodiments, the unsaturated compound (A) has the formula R⁴—Z—R⁴, where Z is a divalent linking group, which may be a divalent hydrocarbon, a polyoxyalkylene, a polyalkylene, a polyisoalkylene, a hydrocarbon-silicone copolymer, a siloxane, or mixtures (in block or randomized form) thereof. Z may be linear or branched. In these specific embodiments, R⁴ is independently selected and includes aliphatic unsaturation, i.e., each R⁴ is independently selected from alkenyl groups and alkynyl groups. However, the aliphatic unsaturation need not be terminal in the unsaturated compound (A).

In these specific embodiments, the unsaturated compound (A) includes two aliphatically unsaturated groups represented by R⁴.

In one embodiment of the unsaturated compound (A), Z is a divalent hydrocarbon. The divalent hydrocarbon Z may contain 1 to 30 carbons, either as aliphatic or aromatic structures, and may be branched or unbranched. Alternatively, the linking group Z may be an alkylene group containing 1 to 12 carbons. In these embodiments, the unsaturated compound (A) may be selected from a, w-unsaturated hydrocarbons. The α, ω-unsaturated hydrocarbons may alternatively be referred to as olefins.

For example, the unsaturated compound (A) may be any diene, diyne or ene-yne compound. With reference to the formula above, in these embodiments, R⁴ may be, for example, independently selected from CH₂═CH—, CH₂═CHCH₂—, CH₂═CH(CH₂)₄—, CH₂═C(CH₃)CH₂— or and similar substituted unsaturated groups such as H₂C═C(CH₃)—, and HC═C(CH₃)—. In such embodiments, the unsaturated compound (A) may be referred to as an α,ω-unsaturated hydrocarbon. The α,ω-unsaturated hydrocarbon may be, for example, an α,ω-diene of the formula CH₂═CH(CH₂)_{b}CH═CH₂, an α,ω-diyne of the formula CH≡C(CH₂)_{b}C═CH, an α,ω-ene-yne of the formula CH₂═CH(CH₂)_{b}C≡CH, or mixtures thereof, where b is independently from 0 to 20, alternatively from 1 to 20.

Specific examples of suitable diene, diyne or ene-yne compounds include 1,4-pentadiene, 1,5-hexadiene; 1,6-heptadiene; 1,7-octadiene, 1,8-nonadiene, 1,9-decadiene, 1,11-dodecadiene, 1,13-tetradecadiene, and 1,19-eicosadiene, 1,3-butadiyne, 1,5-hexadiyne (dipropargyl), and 1-hexene-5-yne.

However, the unsaturated compound (A) may alternatively have the formula R⁴—Z′, where R⁴ is defined above and Z′ is a monovalent hydrocarbon group (or silyl or siloxane group). In these specific embodiments, the unsaturated compound (A) includes one aliphatically unsaturated group represented by R⁴.

When the unsaturated compound (A) includes only one aliphatically unsaturated group, the unsaturated compound (A) may be referred to as an unsaturated hydrocarbon, and may be any-ene or-yne compound. In such embodiments, the unsaturated compound (A) may be an acyclic alkene and/or an acyclic alkyne. However, the unsaturated compound (A) may include aryl groups so long as the unsaturated compound (A) also includes the at least one aliphatically unsaturated group independent from any aryl groups, e.g. pendent therefrom.

In another embodiment, the unsaturated compound (A) comprises, alternatively is, a polyether. In these embodiments, the unsaturated compound (A) comprises a polyoxyalkylene group having the formula (CₐH₂ₐO), wherein a is from 2 to 4 inclusive. With reference to the general formula above, Z′ is the polyoxyalkylene group. In these embodiments, the unsaturated compound (A) may be referred to as the polyoxyalkylene.

The polyoxyalkylene may comprise oxyethylene units (C₂H₄O), oxypropylene units (C₃H₆O), oxybutylene or oxytetramethylene units (C₄H₈O), or mixtures thereof, which may be in block form or randomized in the unsaturated compound (A).

For example, the unsaturated compound (A) as the polyoxyalkylene may have the following general formula:

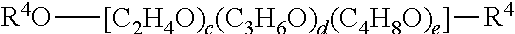

wherein each R⁴ is independently selected and defined above; c is from 0 to 200, d is from 0 to 200, and e is from 0 to 200, with the proviso that c, d and e are not simultaneously 0. In specific embodiments, c is from 0 to 50, alternatively from 0 to 10, alternatively from 0 to 2. In these or other embodiments, d is from 0 to 100, alternatively 1 to 100, alternatively 5 to 50. In these or other embodiments, e is from 0 to 100, alternatively 0 to 50, alternatively 0 to 30. In various embodiments, the ratio of (d+e)/(c+d+e) is greater than 0.5, alternatively greater than 0.8, or alternatively greater than 0.95.

This polyoxyalkylene is terminated at each molecular chain end (i.e. alpha and omega positions) with R⁴, which is independently selected and described above. Additional examples of R² include H₂C═C(CH₃)CH₂—H₂C═CHCH₂CH₂—, H₂C═CHCH₂CH₂CH₂—, and H₂C═CHCH₂CH₂CH₂CH₂—, HC≡C—, HC≡CCH₂—, HC≡CCH(CH₃)—, HC≡CC(CH₃)₂—, HC≡CC(CH₃)₂CH₂—. However, the polyoxyalkylene set forth above is merely one exemplary example of a suitable polyoxyalkylene.

In specific embodiments, the polyoxyalkylene group comprises only oxypropylene units (C₃H₆O). Representative, non-limiting examples of polyoxypropylene-containing polyoxyalkylenes include: H₂C═CHCH₂[C₃H₆O]_{d}CH₂CH═CH₂, H₂C═CH[C₃H₆O]_{d}CH═CH₂, H₂C═C(CH₃)CH₂[C₃H₆O]_{d}CH₂C(CH₃)═CH₂, HC≡CCH₂[C₃H₆O]_{d}CH₂C═CH, and HC≡CC (CH₃)₂[C₃H₆O]_{d}C(CH₃)₂C≡CH, where d is as defined above.

Representative, non-limiting examples of polyoxybutylene or poly (oxytetramethylene) containing polyoxyalkylenes include: H₂C═CHCH₂[C₄H₈O]ₑCH₂CH═CH₂, H₂C═CH[C₄H₈O]ₑCH═CH₂, H₂C═C(CH₃)CH₂[C₄H₈O]ₑCH₂C(CH₃)═CH₂, HC≡CCH₂[C₄H₈O]ₑCH2C≡CH, and HC≡CC(CH₃)₂[C₄H₈O]ₑC(CH₃)₂C≡CH, where e is as defined above.

The examples of polyoxyalkylenes suitable for (A) the unsaturated compound include two aliphatically unsaturated groups. However, the polyoxyalkylene suitable for (A) the unsaturated compound may include only one aliphatically unsaturated group. For example, the polyoxyalkylene suitable for (A) the unsaturated compound may alternatively have the following general formula:

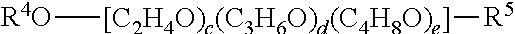

where R⁴, c, d, and e are defined above, and R⁵ is H or an alkyl group, such as CH₃. Any description or examples above also apply to this embodiment as well. One of skill in the art readily understands how the examples of polyoxyalkylenes above with two aliphatically unsaturated groups may alternatively include but one aliphatically unsaturated group.

The polyoxyalkylene may be prepared by, for example, the polymerization of ethylene oxide, propylene oxide, butylene oxide, 1,2-epoxyhexane, 1,2-epoxyoctance, and/or cyclic epoxides, such as cyclohexene oxide or exo-2,3-epoxynorborane. The polyoxyalkylene moiety of the polyoxyalkylene may comprise oxyethylene units (C₂H₄O), oxypropylene units (C₃H₆O), oxybutylene units (C₄H₈O), or mixtures thereof. Typically, the polyoxyalkylene group comprises a majority of oxypropylene or oxybutylene units, as defined on a molar basis and indicated in the above formula by the c, d, and e subscripts.

In another embodiment, Z of the general formula R⁴—Z—R⁴ or Z′ or the formula R⁴—Z′ of the unsaturated compound (A) comprises a polyalkylene group. The polyalkylene group may comprise from C₂ to C₆ alkylene units or their isomers. One specific example is polyisobutylene group, which is a polymer including isobutylene units. For example, the unsaturated compound (A) may be a di-allyl terminated polyisobutylene or an allyl-terminated polyisobutylene. The molecular weight of the polyisobutylene group may vary, but typically ranges from 100 to 10,000 g/mole.

In certain embodiments, the unsaturated compound (A) comprises an organopolysiloxane. The organopolysiloxane is not limited and may be any organopolysiloxane including at least one silicon-bonded aliphatically unsaturated group per molecule. For example, the organopolysiloxane may be linear, branched, partly branched, cyclic, resinous (i.e., have a three-dimensional network), or may comprise a combination of different structures. When the unsaturated compound (A) comprises the organopolysiloxane, the aliphatically unsaturated group is silicon-bonded (e.g. as silicon-bonded alkenyl and/or silicon-bonded alkynyl).

In certain embodiments when the unsaturated compound (A) comprises an organopolysiloxane, the organopolysiloxane has the following average formula:

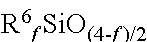

wherein each R⁶ is an independently selected substituted or unsubstituted hydrocarbyl group with the proviso that in each molecule, at least one, alternatively at least two, R⁶ groups is an aliphatically unsaturated group, and wherein f is selected such that 0<f≤3.2.

The average formula above for the organopolysiloxane may be alternatively written as (R⁶₃SiO_{1/2})_{w}(R⁶₂SiO_{2/2})ₓ(R⁶SiO_{3/2})_{y}(SiO_{4/2})_{z}, where R⁶ and its proviso is defined above, and w, x, y, and z are independently from ≥0 to ≤1, with the proviso that w+x+y+z=1. One of skill in the art understands how such M, D, T, and Q units and their molar fractions influence subscript f in the average formula above. T and Q units, indicated by subscripts y and z, are typically present in silicone resins, whereas D units, indicated by subscript x, are typically present in silicone polymers (and may also be present in silicone resins).

Each R⁶ is independently selected, as introduced above, and may be linear, branched, cyclic, or combinations thereof. In general, hydrocarbyl groups suitable for R⁶ may independently be linear, branched, cyclic, or combinations thereof. Cyclic hydrocarbyl groups encompass aryl groups as well as saturated or non-conjugated cyclic groups. Cyclic hydrocarbyl groups may independently be monocyclic or polycyclic. Linear and branched hydrocarbyl groups may independently be saturated or unsaturated. One example of a combination of a linear and cyclic hydrocarbyl group is an aralkyl group. General examples of hydrocarbyl groups include alkyl groups, aryl groups, alkenyl groups, halocarbon groups, and the like, as well as derivatives, modifications, and combinations thereof. Examples of suitable alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, hexadecyl, octadecyl, as well as branched saturated hydrocarbon groups having from 6 to 18 carbon atoms. Examples of suitable non-conjugated cyclic groups include cyclobutyl, cyclohexyl, and cycyloheptyl groups. Examples of suitable aryl groups include phenyl, tolyl, xylyl, naphthyl, benzyl, and dimethyl phenyl. Examples of suitable alkenyl groups include vinyl, allyl, propenyl, isopropenyl, butenyl, isobutenyl, pentenyl, heptenyl, hexenyl, hexadecenyl, octadecenyl and cyclohexenyl groups. Examples of suitable monovalent halogenated hydrocarbon groups (i.e., halocarbon groups, or substituted hydrocarbon groups) include halogenated alkyl groups, aryl groups, and combinations thereof. Examples of halogenated alkyl groups include the alkyl groups described above where one or more hydrogen atoms is replaced with a halogen atom such as F or Cl. Specific examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl, chloromethyl, chloropropyl, 2-dichlorocyclopropyl, and 2,3-dichlorocyclopentyl groups, as well as derivatives thereof. Examples of halogenated aryl groups include the aryl groups described above where one or more hydrogen atoms is replaced with a halogen atom, such as For Cl. Specific examples of halogenated aryl groups include chlorobenzyl and fluorobenzyl groups.

In certain embodiments, the organopolysiloxane is substantially linear, alternatively is linear. By substantially linear, it is meant that the organopolysiloxane can include at least some branching attributable to T or Q, typically T, siloxy units, so long as at least 90, alternatively at least 95, mol % of siloxy units are D siloxy units. In these embodiments, the substantially linear organopolysiloxane may have the average formula:

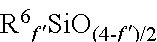

wherein each R⁶ and its proviso are defined above, and wherein f′ is selected such that 1.9≤f′≤2.2.

In these embodiments, at a temperature of 25° C., the substantially linear organopolysiloxane is typically a flowable liquid or is in the form of an uncured rubber. Generally, the substantially linear organopolysiloxane has a viscosity of from 10 to 30,000,000 mPa·s, alternatively from 10 to 10,000 mPa·s, alternatively from 100 to 1,000,000 mPa·s, alternatively from 100 to 100,000 mPa·s, at 25° C. Viscosity may be measured at 25° C. via a Brookfield LV DV-E viscometer, as understood in the art.

In specific embodiments in which the organopolysiloxane is substantially linear or linear, the organopolysiloxane may have the average formula:

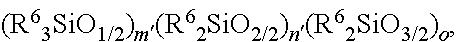

wherein each R⁶ is independently selected and defined above (including the proviso that in each molecule, at least one R⁶ is an aliphatically unsaturated group), and m′≥2, n′≥1, and o≥0. In specific embodiments, subscript m′ is from 2 to 10, alternatively from 2 to 8, alternatively from 2 to 6. In these or other embodiments, subscript n′ is from 1 to 1,000, alternatively from 1 to 500, alternatively from 1 to 200. In these or other embodiments, subscript o is from 0 to 10, alternatively from 0 to 5, alternatively from 0 to 2. As understood in the art, when subscript o is 0, the organopolysiloxane is linear.

When the organopolysiloxane is substantially linear, alternatively is linear, the silicon-bonded aliphatically unsaturated group(s) may be pendent, terminal or in both pendent and terminal locations. As a specific example of the organopolysiloxane having pendant silicon-bonded aliphatically unsaturated groups, the organopolysiloxane may have the average formula:

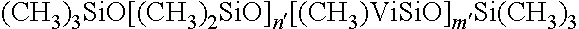

where n′ and m′ are defined above, and Vi indicates a vinyl group. With regard to this average formula, one of skill in the art knows that any methyl group may be replaced with a vinyl or a substituted or unsubstituted hydrocarbyl group, and any vinyl group may be replaced with any ethylenically unsaturated group, so long as at least two aliphatically unsaturated groups are present per molecule. Alternatively, as a specific example of the organopolysiloxane having terminal silicon-bonded aliphatically unsaturated groups, the organopolysiloxane may have the average formula:

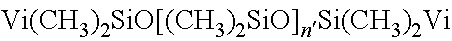

where n′ and Vi are defined above. The dimethyl polysiloxane terminated with silicon-bonded vinyl groups may be utilized alone or in combination with the dimethyl, methyl-vinyl polysiloxane disclosed immediately above. With regard to this average formula, one of skill in the art knows that any methyl group may be replaced with a vinyl or a substituted or unsubstituted hydrocarbyl group, and any vinyl group may be replaced with any ethylenically unsaturated group, so long as at least two aliphatically unsaturated groups are present per molecule. Because the at least two silicon-bonded aliphatically unsaturated groups may be both pendent and terminal, the (A) organopolysiloxane may have the average formula:

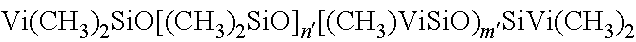

where n′, m′ and Vi are defined above.

The substantially linear organopolysiloxane can be exemplified by a dimethylpolysiloxane capped at both molecular terminals with dimethylvinylsiloxy groups, a methylphenylpolysiloxane capped at both molecular terminals with dimethylvinylsiloxy groups, a copolymer of a methylphenylsiloxane and dimethylsiloxane capped at both molecular terminals with dimethylvinylsiloxy groups, a copolymer of a methylvinylsiloxane and a methylphenylsiloxane capped at both molecular terminals with dimethylvinylsiloxy groups, a copolymer of a methylvinylsiloxane and diphenylsiloxane capped at both molecular terminals with dimethylvinylsiloxy groups, a copolymer of a methylvinylsiloxane, methylphenylsiloxane, and dimethylsiloxane capped at both molecular terminals with dimethylvinylsiloxy groups, a copolymer of a methylvinylsiloxane and a methylphenylsiloxane capped at both molecular terminals with trimethylsiloxy groups, a copolymer of a methylvinylsiloxane and diphenylsiloxane capped at both molecular terminals with trimethylsiloxy groups, and a copolymer of a methylvinylsiloxane, methylphenylsiloxane, and a dimethylsiloxane capped at both molecular terminals with trimethylsiloxy groups.

In these or other embodiments, the (A) organopolysiloxane may be a resinous organopolysiloxane. In these embodiments, the resinous organopolysiloxane may have the average formula:

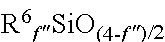

wherein each R⁶ and its provisos are defined above, and wherein f″ is selected such that 0.5≤f″≤1.7.

The resinous organopolysiloxane has a branched or a three dimensional network molecular structure. At 25° C., the resinous organopolysiloxane may be in a liquid or in a solid form, optionally dispersed in a carrier, which may solubilize and/or disperse the resinous organopolysiloxane therein.

In specific embodiments, the resinous organopolysiloxane may be exemplified by an organopolysiloxane that comprises only T units, an organopolysiloxane that comprises T units in combination with other siloxy units (e.g. M, D, and/or Q siloxy units), or an organopolysiloxane comprising Q units in combination with other siloxy units (i.e., M, D, and/or T siloxy units). The resinous organopolysiloxane comprises T and/or Q units. A specific example of the resinous organopolysiloxane is a vinyl functional silsesquioxane, or a vinyl functional MQ resin.

The organopolysiloxane may comprise a combination or mixture of different organopolysiloxanes, including those of different structures.

Alternatively, the unsaturated compound (A) may be a silicone-organic hybrid. For example, the unsaturated compound (A) may comprise the hydrosilylation reaction product of organopolysiloxanes (or of one or more organopolysiloxanes with one or more organic compounds), in which case the backbone of the unsaturated compound (A) may include organic divalent linking groups. As another example, organohydrogensiloxanes may be reacted with other organopolysiloxanes, or with organic compounds, to give the unsaturated compound (A).

For example, the unsaturated compound (A) may be the reaction product of (a1) at least one Si—H compound and (b1) at least one compound having ethylenic unsaturation. In these embodiments, a molar excess of ethylenic unsaturated groups of the (b1) compound are utilized as compared to Si—H groups of the (a1) Si—H compound such that the unsaturated compound (A) includes at least one, alternatively an average of at least two, silicon-bonded aliphatically unsaturated groups.

The reaction product of the (a1) Si—H compound and the (b1) compound having ethylenic unsaturation may be referred to as an (AB) n type copolymer, with the (a1) Si—H compound forming units A and the (b1) compound having ethylenic unsaturation forming units B. Combinations of different (a1) Si—H compounds may be utilized, and combinations of different (b1) compounds having ethylenic unsaturation may be utilized, such that the resulting (b) crosslinking agent comprises distinct units but may not be an (AB) n type copolymer. The distinct units may be randomized or in block form.

Alternatively still, the unsaturated compound (A) may comprise an organosilicon-compound, but not an organopolysiloxane. For example, the unsaturated compound (A) may comprise a silane, a disilane, or a siloxane (for example a disiloxane), while not constituting an organopolysiloxane.

One example of a suitable silane is that of formula R⁷_{z″}SiR⁸_{4-z″}, where each R⁷ independently is an aliphatically unsaturated group, each R⁸ is independently a substituted or unsubstituted hydrocarbyl group, and 1≤z″≤4. One example of a siloxane is tetramethyldivinyldisiloxane. One of skill in the art understands how to prepare or obtain such compounds for use as the unsaturated compound (A).

The unsaturated compound (A) can be a single unsaturated compound or a combination comprising two or more different silicon hydride compounds.

The composition and unsaturated compound (A) are subject to at least one of the following two provisos: (1) the unsaturated compound (A) also includes at least one silicon-bonded hydrogen atom per molecule; and/or (2) the composition further comprises (B) a silicon hydride compound including at least one silicon-bonded hydrogen atom per molecule.

In a first embodiment, the proviso (1) is true such that the unsaturated compound (A) also includes at least one silicon-bonded hydrogen atom per molecule. In a second embodiment, the proviso (2) is true such that the composition further comprises (B) a silicon hydride compound including at least one silicon-bonded hydrogen atom per molecule. Finally, in a third embodiment, both proviso (1) and proviso (2) are true such that the unsaturated compound (A) also includes at least one silicon-bonded hydrogen atom per molecule, and that the composition further comprises (B) a silicon hydride compound including at least one silicon-bonded hydrogen atom per molecule.

In the first embodiment, the proviso (1) is true and the unsaturated compound (A) includes at least one silicon-bonded hydrogen atom per molecule in addition to the aliphatically unsaturated group. In these embodiments, the unsaturated compound (A) may be any compound including at least one silicon-bonded hydrogen atom and at least one aliphatically unsaturated group. In these embodiments, the unsaturated compound (A) is typically an organosilicon compound and/or an organopolysiloxane.

One of skill in the art readily understands how to prepare or obtain such unsaturated compounds. For example, organosilicon compounds including both aliphatic unsaturated and silicon-bonded hydrogen may be prepared from the unsaturated organic compounds disclosed above. As but one example, an α,ω-diene of the formula CH₂═CH(CH₂)_{b}CH═CH₂ may be reacted with a silane of formula H₂Si(CH₃)₂ in the presence of a hydrosilylation catalyst to give an unsaturated compound of formula CH₂═CH(CH₂)_{b}CH₂CH₂Si(CH₃)₂H, which includes one aliphatically unsaturated group and one silicon-bonded hydrogen atom. The organosilicon compound may also be a silane, disilane, siloxane, etc. For example, the organosilicon compound may be of formula R⁷_{b′}H_{c′}SiR⁸_{4-b′-c′}, where R⁷ and R⁸ are independently selected and defined above, b′is 1, 2, or 3, c′ is 1, 2, or 3, with the proviso that 2≤(b′+c′)≤4.

When the unsaturated compound (A) comprises the organopolysiloxane having both aliphatic unsaturation and silicon-bonded hydrogen, the organopolysiloxane may have the formula R⁶_{d′}H_{e′}SiO_{(4-d′-e′)/2}, where R⁶ is independently selected and defined above (still subject to the proviso that at least one R⁶ is the aliphatically unsaturated group), and e′ and f′ are each greater than 0 such that 0<(d′+e′)≤3.2.

Alternatively, when the unsaturated compound (A) comprises the organopolysiloxane having both aliphatic unsaturation and silicon-bonded hydrogen, the silicon-bonded aliphatically unsaturated group(s) and the silicon-bonded hydrogen atom(s) may be present in any M, D, and/or T siloxy unit present in the organopolysiloxane, and may be bonded to the same silicon atom (in the case of M and/or D siloxy units). The organopolysiloxane may comprise, for example, as M siloxy units: (R⁶₃SiO_{1/2}), (R⁶₂HSiO_{1/2}), (R⁶H₂SiO_{1/2}), and/or (H₃SiO_{1/2}). The organopolysiloxane may comprise, for example, as D siloxy units: (R⁶₂SiO_{2/2}), (R⁶HSiO_{2/2}), and/or (H₂SiO_{2/2}). The organopolysiloxane may comprise, for example, as T siloxy units: (R⁶SiO_{3/2}) and/or (HSiO_{3/2}). Such siloxy units may be combined in any manner, optionally along with Q siloxy units, to give an organopolysiloxane having at least one silicon-bonded aliphatically unsaturated group designated by R⁶ and at least one silicon-bonded hydrogen atom.

For example, the organopolysiloxane may have any one of the following formulas:

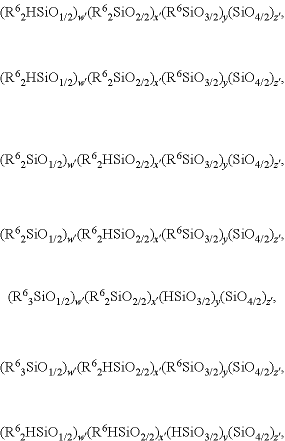

and/or etc., where each R⁶ is independently selected and defined above (with at least one R⁶ being an aliphatically unsaturated group), and w′, x′, y′, and z′ are independently from ≥0 to ≤1, with the proviso that w′+x′+y′+z″=1.

In the second embodiment, the proviso (2) is true and the composition further comprises (B) a silicon hydride compound including at least one silicon-bonded hydrogen atom per molecule. In these embodiments, the silicon hydride compound (B) may be any compound including at least one silicon-bonded hydrogen atom. Depending on a structure of the silicon hydride compound (B), the silicon hydride compound (B) may be a silane compound, an organosilicon compound, an organohydrogensilane, an organohydrogensiloxane, etc.

The silicon hydride compound (B) can be linear, branched, cyclic, resinous, or have a combination of such structures. In acyclic polysilanes and polysiloxanes, the silicon-bonded hydrogen atom(s) can be located at terminal, pendant, or at both terminal and pendant positions. Cyclosilanes and cyclosiloxanes typically have from 3 to 12 silicon atoms, alternatively from 3 to 10 silicon atoms, alternatively from 3 to 4 silicon atoms.

In certain embodiments, the silicon hydride compound (B) is of formula R⁹₄₋ₛSiHₛ, where R⁹ is independently selected and may be any silicon-bonded group, and s is selected such that 1≤s≤4. Typically, s is 1, 2, or 3, alternatively 1 or 2. Each R⁹ is typically independently a substituted or unsubstituted hydrocarbyl group, suitable examples of which are described above. However, R⁹ can be any silicon-bonded group so long as the silicon hydride (B) is still capable of undergoing hydrosilylation via its silicon-bonded hydrogen atom. For example, R⁹ can be a halogen. When the silicon hydride (B) is a silane compound, the silicon hydride (B) can be a monosilane, disilane, trisilane, or polysilane.

In these or other embodiments, the silicon hydride compound (B) may be an organosilicon compound of formula: H_{g′}R¹⁰_{3-g′}Si—R¹¹—SiR¹⁰₂H, wherein each R¹⁰ is an independently selected substituted or unsubstituted hydrocarbyl group, g′ is 0 or 1, and R¹¹ is a divalent linking group. R¹¹ may be a siloxane chain (including, for example, —R¹⁰₂SiO—,—R¹⁰HSiO—, and/or —H₂SiO-D siloxy units) or may be a divalent hydrocarbon group. Typically, the divalent hydrocarbon group is free of aliphatic unsaturation. The divalent hydrocarbon group may be linear, cyclic, branched, aromatic, etc., or may have combinations of such structures.

When g′ is 1, and when R¹¹ is a divalent hydrocarbon group, specific examples of the silicon hydride compound (B) include:

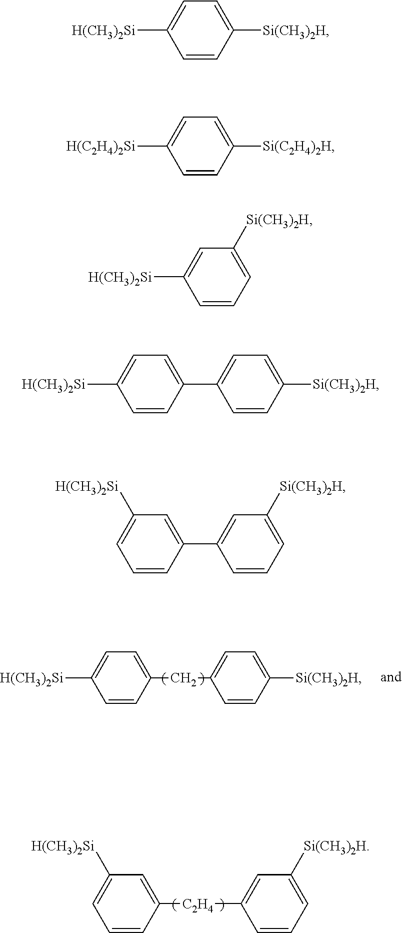

In these or other embodiments, the silicon hydride compound (B) comprises an organohydrogensiloxane, which can be a disiloxane, trisiloxane, or polysiloxane. Examples of organohydrogensiloxanes suitable for use as the silicon hydride compound (B) include, but are not limited to, siloxanes having the following formulae: PhSi(OSiMe₂H)₃, Si(OSiMe₂H)₄, MeSi(OSiMe₂H)₃, and Ph₂Si(OSiMe₂H)₂, wherein Me is methyl, and Ph is phenyl. Additional examples of organohydrogensiloxanes that are suitable for purposes of the silicon hydride compound (B) include 1,1,3,3-tetramethyldisiloxane, 1,1,3,3-tetraphenyldisiloxane, phenyltris (dimethylsiloxy) silane, 1,3,5-trimethylcyclotrisiloxane, a trimethylsiloxy-terminated poly (methylhydrogensiloxane), a trimethylsiloxy-terminated poly (dimethylsiloxane/methylhydrogensiloxane), and a dimethylhydrogensiloxy-terminated poly (methylhydrogensiloxane).

When the silicon hydride compound (B) comprises an organohydrogensiloxane, the silicon hydride compound (B) may comprise any combination of M, D, T and/or Q siloxy units, so long as the silicon hydride compound (B) includes at least one silicon-bonded hydrogen atom. These siloxy units can be combined in various manners to form cyclic, linear, branched and/or resinous (three-dimensional networked) structures. The silicon hydride compound (B) may be monomeric, polymeric, oligomeric, linear, branched, cyclic, and/or resinous depending on the selection of M, D, T, and/or Q units.

Because the silicon hydride compound (B) includes at least one silicon-bonded hydrogen atom, with reference to the siloxy units set forth above, the silicon hydride compound (B) may comprise any of the following siloxy units including silicon-bonded hydrogen atoms, optionally in combination with siloxy units which do not include any silicon-bonded hydrogen atoms: (R¹⁰₂HSiO_{1/2}), (R¹⁰H₂SiO_{1/2}), (H₃SiO_{1/2}), (R¹⁰HSiO_{2/2}), (H₂SiO_{2/2}), and/or (HSiO_{3/2}), where R¹⁰ is independently selected and defined above.

In specific embodiments, for example when the silicon hydride compound (B) is linear, the silicon hydride compound (B) may have the average formula:

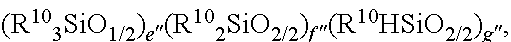

wherein each R¹⁰ is independently hydrogen or R⁸, where each R⁸ is independently selected and defined above, and e″≥2, f′″≥0, and g″≥2. In specific embodiments, e″ is from 2 to 10, alternatively from 2 to 8, alternatively from 2 to 6. In these or other embodiments, f′″ is from 0 to 1,000, alternatively from 1 to 500, alternatively from 1 to 200. In these or other embodiments, g″ is from 2 to 500, alternatively from 2 to 200, alternatively from 2 to 100.

In one embodiment, the silicon hydride compound (B) is linear and includes one or more pendent silicon-bonded hydrogen atoms. In these embodiments, the silicon hydride compound (B) may be a dimethyl, methyl-hydrogen polysiloxane having the average formula;

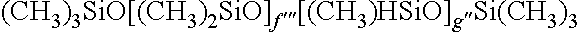

where f′″ and g″ are defined above.

In these or other embodiments, the silicon hydride compound (B) is linear and includes terminal silicon-bonded hydrogen atoms. In these embodiments, the silicon hydride compound (B) may be an SiH terminal dimethyl polysiloxane having the average formula:

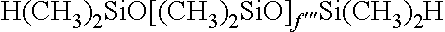

where f′″ is as defined above. The SiH terminal dimethyl polysiloxane may be utilized alone or in combination with the dimethyl, methyl-hydrogen polysiloxane disclosed immediately above. Further, the SiH terminal dimethyl polysiloxane may have one trimethylsiloxy terminal such that the SiH terminal dimethyl polysiloxane may have only one silicon-bonded hydrogen atom. Alternatively still, the (B) organohydrogensiloxane may include both pendent and terminal silicon-bonded hydrogen atoms.

In certain embodiments, the silicon hydride compound (B) may have one of the following average formulas:

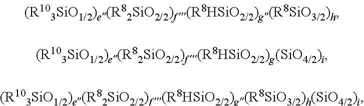

wherein each R¹⁰ and R⁸ is independently selected and defined above, e″, f′″, and g″ are defined above, and h≥0, and i is ≥0. In each of the average formulas above, the sum of the subscripts is 1.

Some of the average formulas above for the silicon hydride compound (B) are resinous when the silicon hydride compound (B) includes T siloxy units (indicated by subscript h) and/or Q siloxy units (indicated by subscript i). When the silicon hydride compound (B) is resinous, the silicon hydride compound (B) is typically a copolymer including T siloxy units and/or Q siloxy units, in combination with M siloxy units and/or D siloxy units. For example, the organohydrogenpolysiloxane resin can be a DT resin, an MT resin, an MDT resin, a DTQ resin, an MTQ resin, an MDTQ resin, a DQ resin, an MQ resin, a DTQ resin, an MTQ resin, or an MDQ resin.

In various embodiments in which the silicon hydride compound (B) is resinous, or comprises an organopolysiloxane resin, the silicon hydride compound (B) typically has the formula:

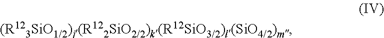

wherein each R¹² independently is H or a substituted or unsubstituted hydrocarbyl group, with the proviso that in one molecule, at least one R¹² is H; and wherein 0≤j′≤1; 0≤k′≤1;0≤l′≤1;and 0≤m″≤1; with the proviso that j′+k′+′+m″=1.

In certain embodiments, the silicon hydride compound (B) may comprise an alkylhydrogen cyclosiloxane or an alkylhydrogen dialkyl cyclosiloxane copolymer, represented in general by the formula (R¹²₂SiO)_{r′}(R¹²HSiO)_{s′}, where R¹² is independently selected and defined above, and where r′ is an integer from 0-7 and s′ is an integer from 3-10. Specific examples of suitable organohydrogensiloxanes of this type include (OSiMeH)₄, (OSiMeH)₃(OSiMeC₆H₁₃), (OSiMeH)₂(OSiMeC₆H₁₃)₂, and (OSiMeH)(OSiMeC₆H₁₃)₃, where Me represents methyl (—CH₃).

The silicon hydride compound (B) can be a single silicon hydride compound or a combination comprising two or more different silicon hydride compounds.

Finally, in a third embodiment, both proviso (1) and proviso (2) are true such that the unsaturated compound (A) also includes at least one silicon-bonded hydrogen atom per molecule, and the composition further comprises (B) a silicon hydride compound including at least one silicon-bonded hydrogen atom per molecule. Examples of suitable unsaturated compounds and silicon hydride compounds for this third embodiment are set forth above.

The unsaturated compound (A), as well as the silicon hydride compound (B), if present in the composition, may be disposed in a carrier vehicle. Examples of carrier vehicles are described.

The composition may comprise the unsaturated compound (A) and the silicon hydride compound (B), when present, in varying amounts or ratios contingent on desired properties or end use application of the composition. In various embodiments when the composition comprises components (A) and (B), the composition comprises components (A) and (B) in an amount to provide a mole ratio of silicon-bonded hydrogen atoms to aliphatically unsaturated groups of from 0.3 to 5, alternatively from 0.6 to 3.

The composition further comprises (C) the encapsulated catalyst as described above.

The encapsulated catalyst (C) is present in the composition in a catalytic amount, i.e., an amount or quantity sufficient to promote a reaction or curing thereof at desired conditions. The catalytic amount of the encapsulated catalyst (C) may be greater than 0.01 ppm, and may be greater than 1,000 ppm (e.g., up to 10,000 ppm or more). In certain embodiments, the typical catalytic amount of catalyst (C) is less than 5,000 ppm, alternatively less than 2,000 ppm, alternatively less than 1,000 ppm (but in any case greater than 0 ppm). In specific embodiments, the catalytic amount of the encapsulated catalyst (C) may range from 0.01 to 1,000 ppm, alternatively from 0.01 to 100, alternatively from 0.01 to 50, alternatively from 0.25 to 50, alternatively from 0.5 to 40, ppm of metal based on the weight of components in the composition. The ranges may relate solely to the metal (i.e., platinum) content within the encapsulated catalyst (C). As understood in the art, the catalytic amount of the encapsulated catalyst may be a function of the selection of components (A) and (B).

The composition may further comprise one or more optional components, including adhesion promoters, carrier vehicles, dyes, pigments, anti-oxidants, heat stabilizers, flame retardants, flow control additives, biocides, fillers (including extending and reinforcing fillers), surfactants, thixotroping agents, organopolysiloxanes, water, carrier vehicles or solvents, pH buffers, etc. In certain embodiments, the composition is free from any hydrosilylation inhibitors. The composition may be in any form and may be incorporated into further compositions, e.g. as a component of a composition. For example, the composition may be in the form of, or incorporated into, an emulsion. The emulsion may be an oil-in-water emulsion, water-in-oil emulsion, silicone-in-oil emulsion, etc. The composition itself may be a continuous or discontinuous phase of such an emulsion.

The composition may be prepared by combining components (A), (B), and (C) along with any optional components, in any order of addition, optionally with a master batch, and optionally under shear.

A method of preparing a hydrosilylation reaction product is also provided. The hydrosilylation reaction product is formed with the composition and may take a variety of forms depending on a section of the components in the composition.

The method comprises reacting an aliphatically unsaturated group and a silicon-bonded hydrogen atom in the presence of the encapsulated catalyst (C). The encapsulated catalyst (C) can be utilized in any hydrosilylation reaction, e.g. in lieu of or in addition to conventional hydrosilylation catalysts. As described above, in certain embodiments, the encapsulated catalyst (C) is not washed prior to its use in the method of preparing a hydrosilylation reaction product.

The aliphatically unsaturated group is present in the unsaturated compound (A). At least one of the following two provisos applies: (1) the unsaturated compound (A) also includes at least one silicon-bonded hydrogen atom per molecule; and/or (2) the silicon-bonded hydrogen atom is present in the silicon hydride (B) compound separate from the unsaturated compound (A). In a first embodiment, the proviso (1) is true such that the unsaturated compound (A) also includes at least one silicon-bonded hydrogen atom per molecule. In a second embodiment, the proviso (2) is true such that the composition further comprises (B) a silicon hydride compound including at least one silicon-bonded hydrogen atom per molecule. Finally, in a third embodiment, both proviso (1) and proviso (2) are true such that the unsaturated compound (A) also includes at least one silicon-bonded hydrogen atom per molecule, and that the composition further comprises the silicon hydride compound (B) including at least one silicon-bonded hydrogen atom per molecule. These embodiments are described in detail above with respect to the composition itself.

The hydrosilylation-reaction product prepared via the method is not limited and is generally a function of the unsaturated compound (A) and, if utilized, the silicon hydride compound (B). For example, the hydrosilylation-reaction product may be monomeric, oligomeric, polymeric, resinous, etc. The hydrosilylation-reaction product may comprise a fluid, an oil, a gel, an elastomer, a rubber, a resin, etc. The hydrosilylation-reaction product may take any form, as understood in the art, based on the selection of the unsaturated compound (A) and, if utilized, the silicon hydride compound (B).

The hydrosilylation-reaction product may also include various byproducts formed via the hydrosilylation reaction. For example, the hydrosilylation-reaction product typically includes a target species and various byproducts. The hydrosilylation-reaction product may also include other components, e.g. a carrier or solvent, if the method and reaction is carried out therein and/or if the composition includes such components. The method may further comprise isolating the target species, e.g. via any suitable purification method. The following examples are intended to illustrate the invention and are not to be viewed in any way as limiting to the scope of the invention.

Certain components utilized in the Examples are set forth in Table 1 below.

TABLE 1
Components/Compounds Utilized

| Component | Description |
|---|---|
| Platinum Complex 1 | Karstedt's catalyst in xylene (~0.02 wt.% Pt) |
| | 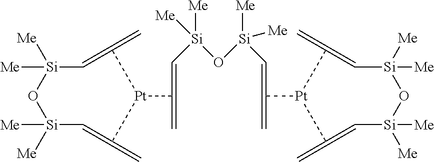 |
| Platinum Complex 2 | As prepared in Preparation Example 1 |
| | 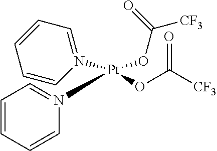 |
| Polymer 1 | Poly(4-vinylpyridine) homopolymer as prepared in Preparation |
| | Example 2 |
| Polymers 2-4 | Copolymers of 4-vinylpyridine and butyl acrylate as prepared in |
| | Preparation Example 3 |
| Polymer 5 | Copolymer of 4-vinylpyridine and styrene as prepared in Preparation |
| | Example 4 |
| Comparative Polymer | Polystyrene (average M_{w} ~350k, average Mₙ ~170k), purchased |
| 1 | from Sigma-Aldrich |
| Comparative Polymer | Poly(butyl acrylate) homopolymers as prepared in Preparation |
| 2 | Example 5 |
| Unsaturated | 1-octene |
| Compound (A) | |
| Silicon Hydride (B) | MD^{H}M (1,1, 1,3,5,5,5-heptamethyltrisiloxane) |
| ppm Pt | Parts per million (mol basis) Pt per combined mols of component |
| | (A) and (B)). |

### Gas Chromatography (GC):

Gas chromatograms were collected using a Shimadzu GC-2010 Plus with a Rxi-5 ms (5% diphenyl, 95% dimethyl polysiloxane) column (14.5 m, 0.25 mm ID). An internal standard of decane was used to quantify conversion. The split ratio was 20:1. The temperature ramp and elution times utilized in GC are below in Tables 2 and 3:

TABLE 2
GC Temperature Ramp:

| Rate (° C./min) | Temp (° C.) | Hold Time (min) |
|---|---|---|
| — | 50 | 1 |
| 5 | 120 | 1 |
| 40 | 225 | 1 |
| 40 | 300 | 2 |

Total Time: 23.50 min

TABLE 3
GC Elution times of analytes:

| Analyte | Elution Time (min) |
|---|---|
| Unsaturated Compound (A) | 3.6 |
| Silicon Hydride (B) | 4.7 |
| Tetraethylorthosilicate | 8.5 |
| Decane (internal standard) | 8.9 |

### Preparation Example 1: Synthesis of Platinum Complex 2

In a dark nitrogen glove box, a scintillation vial was charged with (Py)₂Ptl₂ (0.0200 g, 0.027 mmol, 1 eq), silver trifluoroacetate (0.0135 g, 0.081 mmol, 3 eq) and a stir bar before being coated in electrical tape to avoid light exposure. The reaction was reduced in vacuo after stirring overnight. A white product was rinsed with hexane (3×5 mL) and benzene (3×5 mL) and filtered through a pipette of Diatomaceous Earth. The remaining white product was collected in dichloromethane (5×5 mL) and reduced in vacuo to yield the Platinum Complex 2 in the form of a white powder (cis-(Py)₂Pt (OOCCF₃)₂) in 93% yield. ¹H NMR (500 MHz, Methylene Chloride-d₂) δ 8.64 (d, J=5.3 Hz, 4H), 7.90 (tt, J=7.7, 1.6 Hz, 2H), 7.39 (t, J=7.4 Hz, 4H). ¹⁹F NMR (500 MHz, Methylene Chloride-d₂) δ −75.11. HRMS (ESI⁺): for C₁₂H₁₀F₃N₂O₂ Pt⁺ Calc.: 466.0, Found: 466.0.

### Preparation Example 2: Synthesis of Polymer 1

9.9 mmol of 4-vinylpyridine was added to 100 ml of 1:1 by volume tetrahydrafuran:pyridine to give a mixture. The mixture was then stirred at −78° C. and 0.94 mmol of n-butyllithium initiator was added to give a reaction mixture. The reaction mixture was stirred for 6 h and then quenched with 3 mL of wet tetrahydrafuran, 1 mL of ethanol, 0.5 mL of methanol and 0.5 ml of water. The polymer was isolated by precipitating in 500 ml of pentane and subsequent filtering.

### Preparation Example 3: Synthesis of Polymers 2-4

4-vinylpyridine (4VP) and butyl acrylate (BA) were added to a vessel to a total of 5 mass wt. % in toluene according to Table 4 below. Then, 2 mol % of azobisisobutyronitrile (AIBN) (based on the total moles of 4VP and BA) was added to give a reaction mixture, which was then heated at 80° C. for 18 h, resulting in Polymers 2-4. The Polymers 2-4 were isolated by precipitating in 40 mL pentane.

TABLE 4
Polymers 2-4

| | Target | Actual | | | |
|---|---|---|---|---|---|
| | (molar) | (molar) | Mass | Mass | Isolated |
| Polymer | 4VP:BA | 4VP:BA | 4VP (g) | BA (g) | yield (%) |
| 2 | 1:4.2 | 5:9 | 0.08 | 0.41 | 20 |
| 3 | 1:1 | 2:1 | 0.45 | 0.55 | 25 |
| 4 | 1:2.1 | 1:1 | 0.14 | 0.36 | 35 |

### Preparation Example 4: Synthesis of Polymer 5

A molar ratio of 1:9 equivalents 4VP (52 μL, 5.1 mmol) and styrene (436 μL, 4.6 mmol) were disposed in a vessel with 2 mL of toluene followed by 0.16 mol % of azobisisobutyronitrile (AIBN, 1.3 mg) (based on the total moles of 4VP and styrene) before heating to 80° C. for 18 h, resulting in Polymer 5. Polymer 5 was isolated by precipitation in 10 mL of pentane and dried under vacuum for an isolated yield of 26%. Characterization by ¹H NMR spectroscopy indicated a molar ratio of 1:5 4VP: styrene in the resultant copolymer. Number average molecular weight determined by gel permeation chromatography (GPC) was 3600 g/mol with a dispersity of 2.3. The target molar ratio for Polymer 5 was 1:9 4VP: styrene.

### Preparation Example 5: Synthesis of Comparative Polymer 2

In Preparation Example 5, the general procedure of Preparation Example 4 was generally followed, as shown below in Table 5. Comparative Polymer 2, a poly (butyl acrylate) homopolymer, was isolated by rotary evaporation and vacuum oven drying for solvent and residual monomer removal. Although a nominal amount of 4VP was included when preparing Comparative Polymer 2, characterization by 1H NMR spectroscopy indicated a lack of any 4VP incorporated into the resultant homopolymer.

TABLE 5
Comparative Polymer 2

| | Target | Actual | | | |
|---|---|---|---|---|---|
| Comparative | (molar) | (molar) | Mass | Mass | Isolated |
| Polymer | 4VP:BA | 4VP:BA | 4VP (g) | BA (g) | yield (%) |
| 2 | 1:1080 | 0:1 | 0.038 | 5 | 99 |

### General Encapsulation Procedure 1:

Encapsulated Catalysts formed with Catalyst 1 and Polymers 1~4 are prepared in accordance with General Encapsulation Procedure 1.

In General Encapsulation Procedure 1A, 6 mg of Polymer 1 was first dissolved in 0.2 mL of ethanol in a 20 mL scintillation vial to give a polymer solution. Platinum Complex 1 from a 0.02 wt % Pt stock solution in o-xylene (64 μL, 5.625×10⁻⁸ mol Pt) was then added and allowed to equilibrate with the polymer solution for 30 minutes to give a polymer-catalyst solution (1,000 eq of pyridine moieties per total platinum content). After 30 minutes, 2 mL of silicone oil (500 cSt at 25° C. polydimethylsiloxane) were added dropwise to the polymer-catalyst solution while stirring, resulting in polymer particle formation in a mixture. The mixture was put under vacuum for 1 h and purged with Argon three times (to remove EtOH) before being brought into an Argon atmosphere glovebox overnight prior to its use for catalyzing hydrosilylation.

In General Encapsulation Procedure 1B, 30 mg Polymer 1 was first dissolved in 0.5 mL of ethanol in a 20 mL scintillation vial to give a polymer solution. Platinum Complex 1 from a 0.02 wt % Pt stock solution in o-xylene (64 μL, 5.625×10⁻⁸ mol Pt) was then added and allowed to equilibrate with the polymer solution for 30 minutes to give a polymer-catalyst solution (5,000 eq of pyridine moieties per total platinum content). After 30 minutes, 2 mL of silicone oil (500 cSt at 25° C. polydimethylsiloxane) were added dropwise to the polymer-catalyst solution while stirring, resulting in polymer particle formation in a mixture. The mixture was put under vacuum for 1 h and purged with Argon three times (to remove EtOH) before being brought into an Argon atmosphere glovebox overnight prior to its use for catalyzing hydrosilylation.

In General Encapsulation Procedure 1C, 19 mg Polymer 2 was first dissolved in 0.4 mL of ethanol in a 20 mL scintillation vial to give a polymer solution. Platinum Complex 1 from a 0.02 wt % Pt stock solution in o-xylene (64 μL, 5.625×10⁻⁸ mol Pt) was then added and allowed to equilibrate with the polymer solution for 30 minutes to give a polymer-catalyst solution (1,000 eq of pyridine moieties per total platinum content). After 30 minutes, 2 mL of silicone oil (500 cSt at 25° C. polydimethylsiloxane) were added dropwise to the polymer-catalyst solution while stirring, resulting in polymer particle formation in a mixture. The mixture was put under vacuum for 1 h and purged with Argon three times (to remove EtOH) before being brought into an Argon atmosphere glovebox overnight prior to its use for catalyzing hydrosilylation.

In General Encapsulation Procedure 1D, 5 mg Polymer 3 was first dissolved in 0.2 mL of ethanol in a 20 mL scintillation vial to give a polymer solution. Platinum Complex 1 from a 0.02 wt % Pt stock solution in o-xylene (64 μL, 5.625×10⁻⁸ mol Pt) was then added and allowed to equilibrate with the polymer solution for 30 minutes to give a polymer-catalyst solution (500 eq of pyridine moieties per total platinum content). After 30 minutes, 2 mL of silicone oil (500 cSt at 25° C. polydimethylsiloxane) were added dropwise to the polymer-catalyst solution while stirring, resulting in polymer particle formation in a mixture. The mixture was put under vacuum for 1 h and purged with Argon three times (to remove EtOH) before being brought into an Argon atmosphere glovebox overnight prior to its use for catalyzing hydrosilylation.

In General Encapsulation Procedure 1E, 13 mg Polymer 4 was first dissolved in 0.4 mL of ethanol in a 20 mL scintillation vial to give a polymer solution. Platinum Complex 1 from a 0.02 wt % Pt stock solution in o-xylene (64 μL, 5.625×10⁻⁸ mol Pt) was then added and allowed to equilibrate with the polymer solution for 30 minutes to give a polymer-catalyst solution (1000 eq of pyridine moieties per total platinum content). After 30 minutes, 2 mL of silicone oil (500 cSt at 25° C. polydimethylsiloxane) were added dropwise to the polymer-catalyst solution while stirring, resulting in polymer particle formation in a mixture. The mixture was put under vacuum for 1 h and purged with Argon three times (to remove EtOH) before being brought into an Argon atmosphere glovebox overnight prior to its use for catalyzing hydrosilylation.

Encapsulated Catalysts formed with Catalyst 2 and Polymer 1 or 5 are prepared in accordance with General Encapsulation Procedure 2.

In General Encapsulation Procedure 2A, 61 mg of a 0.097 wt % stock solution of Polymer 1 in ethanol (prepared by dissolving 7.1 mg Polymer 1 in 0.4962 g ethanol to prepare a 1.4 wt % stock solution and then taking a 0.0531 g aliquot of the 1.4 wt % stock solution and diluting it to 0.7752 g with ethanol) was added to a 20 mL scintillation vial along with an additional 0.2 mL of ethanol to give a polymer solution. Platinum Complex 2 from a 1.8 mM Pt stock solution in dichloromethane (32 μL, 5.625×10⁻⁸ mol Pt) was then added and allowed to equilibrate with the polymer solution for 3 hours to give a polymer-catalyst solution (10 eq of pyridine moieties per total platinum content). Then, 2 mL of silicone oil (500 cSt at 25° C. polydimethylsiloxane) were added dropwise to the polymer-catalyst solution while stirring, resulting in polymer particle formation in a mixture. The mixture was put under vacuum for 3 h and purged with Argon three times (to remove EtOH, dichloromethane, and residual pyridine) before being brought into an Argon atmosphere glovebox overnight prior to its use for catalyzing hydrosilylation.

In General Encapsulation Procedure 2B, 45 mg of a 1.4 wt % stock solution of Polymer 1 in ethanol (prepared by dissolving 7.1 mg Polymer 1 in 0.4962 g ethanol) was added to a 20 mL scintillation vial along with an additional 0.2 mL of ethanol to give a polymer solution. Platinum Complex 2 from a 1.8 mM Pt stock solution in dichloromethane (32 μL, 5.625×10⁻⁸ mol Pt) was then added and allowed to equilibrate with the polymer solution for 3 hours to give a polymer-catalyst solution (100 eq of pyridine moieties per total platinum content). Then, 2 mL of silicone oil (500 cSt at 25° C. polydimethylsiloxane) were added dropwise to the polymer-catalyst solution while stirring, resulting in polymer particle formation in a mixture. The mixture was put under vacuum for 3 h and purged with Argon three times (to remove EtOH, dichloromethane, and residual pyridine) before being brought into an Argon atmosphere glovebox overnight prior to its use for catalyzing hydrosilylation.

In General Encapsulation Procedure 2C, 6 mg of Polymer 1 was first dissolved in 0.3 mL of ethanol in a 20 mL scintillation vial to give a polymer solution. Platinum Complex 2 from a 1.8 mM Pt stock solution in dichloromethane (32 μL, 5.625×10⁻⁸ mol Pt) was then added and allowed to equilibrate with the polymer solution for 3 hours to give a polymer-catalyst solution (1000 eq of pyridine moieties per total platinum content). Then, 2 mL of silicone oil (500 cSt at 25° C. polydimethylsiloxane) were added dropwise to the polymer-catalyst solution while stirring, resulting in polymer particle formation in a mixture. The mixture was put under vacuum for 3 h and purged with Argon three times (to remove EtOH, dichloromethane, and residual pyridine) before being brought into an Argon atmosphere glovebox overnight prior to its use for catalyzing hydrosilylation.

In General Encapsulation Procedure 2D, 0.3650 g of a 0.096 wt % stock solution of Polymer 5 in dichloromethane (prepared by dissolving 13.1 mg Polymer 5 in 1.3481 g dichloromethane) was added to a 20 mL scintillation vial to give a polymer solution. Platinum Complex 2 from a 1.8 mM Pt stock solution in dichloromethane (32 μL, 5.625×10⁻⁸ mol Pt) was then added and allowed to equilibrate with the polymer solution for 3 hours to give a polymer-catalyst solution (10 eq of pyridine moieties per total platinum content). Then, 2 mL of silicone oil (500 cSt at 25° C. polydimethylsiloxane) were added dropwise to the polymer-catalyst solution while stirring, resulting in polymer particle formation in a mixture. The mixture was put under vacuum for 3 h and purged with Argon three times (to remove dichloromethane and residual pyridine) before being brought into an Argon atmosphere glovebox overnight prior to its use for catalyzing hydrosilylation.

In General Encapsulation Procedure 2E, 0.0373 g of a 0.096 wt % stock solution of Polymer 5 in dichloromethane (prepared by dissolving 13.1 mg Polymer 5 in 1.3481 g dichloromethane) was added to a 20 mL scintillation vial along with an additional 0.2 mL of dichloromethane to give a polymer solution. Platinum Complex 2 from a 1.8 mM Pt stock solution in dichloromethane (32 μL, 5.625×10⁻⁸ mol Pt) was then added and allowed to equilibrate with the polymer solution for 3 hours to give a polymer-catalyst solution (100 eq of pyridine moieties per total platinum content). Then, 2 mL of silicone oil (500 cSt at 25° C. polydimethylsiloxane) were added dropwise to the polymer-catalyst solution while stirring, resulting in polymer particle formation in a mixture. The mixture was put under vacuum for 3 h and purged with Argon three times (to remove dichloromethane, and residual pyridine) before being brought into an Argon atmosphere glovebox overnight prior to its use for catalyzing hydrosilylation.

In General Encapsulation Procedure 2F, 35.2 mg of Polymer 5 was first dissolved in 0.5 mL of dichloromethane in a 20 mL scintillation vial to give a polymer solution. Platinum Complex 2 from a 1.8 mM Pt stock solution in dichloromethane (32 μL, 5.625×10⁻⁸ mol Pt) was then added and allowed to equilibrate with the polymer solution for 3 hours to give a polymer-catalyst solution (1000 eq of pyridine moieties per total platinum content). Then, 2 mL of silicone oil (500 cSt at 25° C. polydimethylsiloxane) were added dropwise to the polymer-catalyst solution while stirring, resulting in polymer particle formation in a mixture. The mixture was put under vacuum for 3 h and purged with Argon three times (to remove dichloromethane and residual pyridine) before being brought into an Argon atmosphere glovebox overnight prior to its use for catalyzing hydrosilylation.

### Examples 1-31: General Hydrosilylation Procedure

Examples 1-31 demonstrate hydrosilylation reactions according to the disclosure. Examples 1-31 follow a General Hydrosilylation Procedure. In the General Hydrosilylation Procedure, 0.6312 g Unsaturated Compound (A) (5.625 mmol, 1 eq.), 1.2516 g Silicon Hydride (B) (5.625 mmol, 1 eq.), 5 mL heptane, and 0.1 g decane were disposed in a 20 mL scintillation vial, degassed with Argon, and placed into an Argon atmosphere glove box. Hydrosilylation was initiated by the addition of an encapsulated catalyst that was prepared in accordance the general encapsulation procedure identified below in Table 6. The quantity of platinum used corresponded to 78 μL of 0.016 w % Pt (5.625×10−8 mol Pt, 5 ppm Pt in terms of mols Pt per combined mols of components (A) and (B)). The reaction then was heated to the specified temperature listed in Table 6 and conversion was measured after 1 hour and after 12 hours for each specified temperature.

To monitor reaction kinetics, a needle and syringe were utilized to extract ~0.01 ml aliquots from the reaction mixture, which were quenched in 1.5 mL of pentane and analyzed via GC. Aliquots were taken 1 hour and 12 hours after catalyst addition.

In Table 6 below, G.E.C. indicates the General Encapsulation Procedure followed to prepare the encapsulated catalyst of each example; P. indicates which Polymer was utilized in the General Encapsulation Procedure; and Ratio indicates the equivalents of structural units including a pyridine moiety in each Polymer to platinum in each of the encapsulated catalysts utilized.

TABLE 6
Examples 1-31

| | | | | Temp | Conv. at 1 | Conv. at |
|---|---|---|---|---|---|---|
| Example | G.E.C. | A.P. | Ratio | ° C. | hour | 12 hours |
| 1 | 1A | 1 | 1000 | 25 | <5% | <5% |
| 2 | 1B | 1 | 5000 | 25 | <5% | <5% |
| 3 | 1B | 1 | 5000 | 150 | 78% | — |
| 4 | 1C | 2 | 1000 | 25 | <5% | <5% |
| 5 | 1D | 3 | 500 | 25 | <5% | <5% |
| 6 | 1E | 4 | 1000 | 25 | <5% | <5% |
| 7 | 1 | 1 | 1000 | 25 | <5% | <5% |
| 8 | 2A | 1 | 10 | 25 | <5% | n/a |
| 9 | 2B | 1 | 100 | 25 | <5% | n/a |
| 10 | 2C | 1 | 1000 | 25 | <5% | n/a |
| 11 | 2A | 1 | 10 | 50 | >95% | n/a |
| 12 | 2B | 1 | 100 | 50 | <5% | n/a |
| 13 | 2C | 1 | 1000 | 50 | <5% | n/a |
| 14 | 2A | 1 | 10 | 80 | >95% | n/a |
| 15 | 2B | 1 | 100 | 80 | >95% | n/a |
| 16 | 2C | 1 | 1000 | 80 | <5% | n/a |
| 17 | 2A | 1 | 10 | 150 | >95% | n/a |
| 18 | 2B | 1 | 100 | 150 | >95% | n/a |
| 19 | 2C | 1 | 1000 | 150 | >95% | n/a |
| 20 | 2D | 5 | 10 | 25 | <5% | n/a |
| 21 | 2E | 5 | 100 | 25 | <5% | n/a |
| 22 | 2F | 5 | 1000 | 25 | <5% | n/a |
| 23 | 2D | 5 | 10 | 50 | <5% | n/a |
| 24 | 2E | 5 | 100 | 50 | <5% | n/a |
| 25 | 2F | 5 | 1000 | 50 | <5% | n/a |
| 26 | 2D | 5 | 10 | 80 | >95% | n/a |
| 27 | 2E | 5 | 100 | 80 | >95% | n/a |
| 28 | 2F | 5 | 1000 | 80 | <5% | n/a |
| 29 | 2D | 5 | 10 | 150 | >95% | n/a |
| 30 | 2E | 5 | 100 | 150 | >95% | n/a |
| 31 | 2F | 5 | 1000 | 150 | >95% | n/a |

### Comparative Examples 1-10

Comparative Examples 1-10 also generally follow the General Hydrosilylation Procedure, but without the encapsulated catalyst of this disclosure. In the General Hydrosilylation Procedure, 0.6312 g Unsaturated Compound (A) (5.625 mmol, 1 eq.), 1.2516 g Silicon Hydride (B) (5.625 mmol, 1 eq.), 5 mL heptane, and 0.1 g decane were disposed in a 20 mL scintillation vial, degassed with Argon, and placed into an Argon atmosphere glove box. Hydrosilylation was initiated by the addition of a catalyst system identified below in Table 7. Unless otherwise noted below in Table 7, the quantity of platinum used corresponded to 64 μL of 0.02 w % Pt (5.625×10−8 mol Pt, 5 ppm Pt in terms of mols Pt per combined mols of components (A) and (B)).

In Comparative Encapsulation Procedure 1, 0.2 mL of a 2.6 wt % solution of Comparative Polymer 1 in toluene (prepared by dissolving 0.0207 g Comparative Polymer 1 in 0.7 mL of toluene) was first added to a 20 mL scintillation vial. Platinum Complex 1 from a 0.02 wt % Pt stock solution in o-xylene (64 μL, 5.625×10⁻⁸ mol Pt) was then added and allowed to equilibrate with the polymer solution for 30 minutes to give a polymer-catalyst solution. After 30 minutes, 2 mL of silicone oil (500 cSt at 25° C. polydimethylsiloxane) were added dropwise to the polymer-catalyst solution while stirring, resulting in polymer particle formation in a mixture. The mixture was put under vacuum for 1 h and purged with Argon three times (to remove EtOH) before being brought into an Argon atmosphere glovebox overnight prior to its use for catalyzing hydrosilylation.

In Comparative Encapsulation Procedure 2, 26.2 mg of a 2.2 wt % solution of Polymer 1 in ethanol (prepared by dissolving 0.0113 g Polymer 1 in 0.4993 g ethanol) was added to a 20 mL scintillation vial along with an additional 0.2 mL of ethanol to give a polymer solution. Platinum Complex 1 from a 0.02 wt % Pt stock solution in o-xylene (64 μL, 5.625×10⁻⁸ mol Pt) was then added and allowed to equilibrate with the polymer solution for 30 minutes to give a polymer-catalyst solution (100 eq of pyridine moieties per total platinum content). After 30 minutes, 2 mL of silicone oil (500 cSt at 25° C. polydimethylsiloxane) were added dropwise to the polymer-catalyst solution while stirring, resulting in polymer particle formation in a mixture. The mixture was put under vacuum for 1 h and purged with Argon three times (to remove EtOH) before being brought into an Argon atmosphere glovebox overnight prior to its use for catalyzing hydrosilylation.

In Comparative Encapsulation Procedure 3, 67.2 mg of a 2.2 wt % solution of Polymer 1 in ethanol (prepared by dissolving 0.0113 g Acrylate 1 in 0.4993 g ethanol) was added to a 20 mL scintillation vial along with an additional 0.1 mL of ethanol to give a polymer solution. Platinum Complex 1 from a 0.02 wt % Pt stock solution in o-xylene (64 μL, 5.625×10⁻⁸ mol Pt) was then added and allowed to equilibrate with the polymer solution for 30 minutes to give a polymer-catalyst solution (250 eq of pyridine moieties per total platinum content). After 30 minutes, 2 mL of silicone oil (500 cSt at 25° C. polydimethylsiloxane) were added dropwise to the polymer-catalyst solution while stirring, resulting in polymer particle formation in a mixture. The mixture was put under vacuum for 1 h and purged with Argon three times (to remove EtOH) before being brought into an Argon atmosphere glovebox overnight prior to its use for catalyzing hydrosilylation.

In Comparative Encapsulation Procedure 4, 0.1338 g of a 2.2 wt % solution of Polymer 1 in ethanol (prepared by dissolving 0.0113 g Polymer 1 in 0.4993 g ethanol) was added to a 20 mL scintillation vial to give a polymer solution. Platinum Complex 1 from a 0.02 wt % Pt stock solution in o-xylene (64 μL, 5.625×10⁻⁸ mol Pt) was then added and allowed to equilibrate with the polymer solution for 30 minutes to give a polymer-catalyst solution (500 eq of pyridine moieties per total platinum content). After 30 minutes, 2 mL of silicone oil (500 cSt at 25° C. polydimethylsiloxane) were added dropwise to the polymer-catalyst solution while stirring, resulting in polymer particle formation in a mixture. The mixture was put under vacuum for 1 h and purged with Argon three times (to remove EtOH) before being brought into an Argon atmosphere glovebox overnight prior to its use for catalyzing hydrosilylation.

In Comparative Encapsulation Procedure 5, 6 mg of Polymer 1 was first dissolved in 0.3 mL of ethanol in a 20 mL scintillation vial to give a polymer solution. Platinum Complex 1 from a 0.02 wt % Pt stock solution in o-xylene (128 μL, 5.625×10⁻⁸ mol Pt) was then added and allowed to equilibrate with the polymer solution for 30 minutes to give a polymer-catalyst solution (500 eq of pyridine moieties per total platinum content). After 30 minutes, 2 mL of silicone oil (500 cSt at 25° C. polydimethylsiloxane) were added dropwise to the polymer-catalyst solution while stirring, resulting in polymer particle formation in a mixture. The mixture was put under vacuum for 1 h and purged with Argon three times (to remove EtOH) before being brought into an Argon atmosphere glovebox overnight prior to its use for catalyzing hydrosilylation.

In Comparative Encapsulation Procedure 6, 0.1189 g of a 5 wt % solution of Polymer 1 in ethanol, prepared by dissolving 0.0199 g Polymer 1 in 0.3801 g ethanol) was added to a 20 mL scintillation vial along with an additional 0.1 mL of ethanol to give a polymer solution. Platinum Complex 1 from a 0.02 wt % Pt stock solution in o-xylene (256 μL, 5.625×10⁻⁸ mol Pt) was then added and allowed to equilibrate with the polymer solution for 30 minutes to give a polymer-catalyst solution. After 30 minutes, 2 mL of silicone oil (500 cSt at 25° C. polydimethylsiloxane) were added dropwise to the polymer-catalyst solution while stirring, resulting in polymer particle formation in a mixture. The mixture was put under vacuum for 1 h and purged with Argon three times (to remove EtOH) before being brought into an Argon atmosphere glovebox overnight prior to its use for catalyzing hydrosilylation.

In Comparative Encapsulation Procedure 7, 7.1 mg of Comparative Polymer 2 was first dissolved in 0.2 mL of ethanol to give a polymer solution. Platinum Complex 1 from a 0.02 wt % Pt stock solution in o-xylene (64 μL, 5.625×10⁻⁸ mol Pt) was then added and allowed to equilibrate with the polymer solution for 30 minutes to give a polymer-catalyst solution. After 30 minutes, 2 mL of silicone oil (500 cSt at 25° C. polydimethylsiloxane) were added dropwise to the polymer-catalyst solution while stirring, resulting in polymer particle formation in a mixture. The mixture was put under vacuum for 1 h and purged with Argon three times (to remove EtOH) before being brought into an Argon atmosphere glovebox overnight prior to its use for catalyzing hydrosilylation.

TABLE 7
Catalyst Systems of Comparative Examples 1-10

| Comparative Example | Catalyst System |
|---|---|
| 1 | Platinum Complex 1 |
| 2 | Platinum Complex 1 encapsulated with polystyrene in |
| | accordance with Comparative Encapsulation |
| | Procedure 1 |
| 3 | Platinum Complex 1 with 1000 eq. pyridine per total |
| | platinum content |
| 4 | Platinum Complex 1 with 1000 eq. 4-vinylpyridine per |
| | total platinum content |
| 5 | Encapsulated Catalyst prepared in accordance with |
| | Comparative Encapsulation Procedure 2 (100 |
| | equivalents of pyridine moieties relative to total |
| | platinum content) |
| 6 | Encapsulated Catalyst prepared in accordance with |
| | Comparative Encapsulation Procedure 3 (250 |
| | equivalents of pyridine moieties relative to total |
| | platinum content) |
| 7 | Encapsulated Catalyst prepared in accordance with |
| | Comparative Encapsulation Procedure 4 (500 |
| | equivalents of pyridine moieties relative to total |
| | platinum content) |
| 8 | Encapsulated Catalyst prepared in accordance with |
| | Comparative Encapsulation Procedure 5 (500 |
| | equivalents of pyridine moieties relative to total |
| | platinum content at a loading of 10 ppm Platinum |
| | Complex 1) |
| 9 | Encapsulated Catalyst prepared in accordance with |
| | Comparative Encapsulation Procedure 6 (250 |
| | equivalents of pyridine moieties relative to total |
| | platinum content at a loading of 20 ppm Platinum |
| | Complex 1) |
| 10 | Platinum Complex 1 encapsulated with Comparative |
| | Polymer 2 in accordance with Comparative |
| | Encapsulation Procedure 7 |

Each reaction of each Comparative Example was then was heated to the specified temperature listed in Table 8 and conversion was measured after 1 hour and after 12 hours for each specified temperature. To monitor reaction kinetics, a needle and syringe were utilized to extract ~0.01 mL aliquots from the reaction mixture, which were quenched in 1.5 mL of pentane and analyzed via GC. Aliquots were taken 1 hour and 12 hours after catalyst addition. Ratio in Table 8 indicates the equivalents of structural units including a pyridine moiety to total platinum in each of the encapsulated catalysts utilized, where applicable (i.e., only in Comparative Examples 5-7).

TABLE 8
Comparative Examples 1-10

| Comparative | | Ppm | Temp | Conv. at | Conv. at |
|---|---|---|---|---|---|
| Example | Ratio | Pt | ° C. | 1 hour | 12 hours |
| 1 | n/a | 5 | 25 | >95% | >95% |
| 2 | n/a | 5 | 25 | >95% | >95% |
| 3 | n/a | 5 | 25 | 48% | 81% |
| 4 | n/a | 5 | 25 | <5% | 9% |
| 5 | 100 | 5 | 25 | >95% | >95% |
| 6 | 250 | 5 | 25 | <5% | 21% |
| 7 | 500 | 5 | 25 | <5% | 46% |
| 8 | 500 | 10 | 25 | <5% | 10% |
| 9 | 250 | 20 | 25 | >95% | >95% |
| 10 | n/a | 5 | 25 | >95% | >95% |

1. An encapsulated catalyst for hydrosilylation, said encapsulated catalyst comprising:
platinum(0) and/or platinum (II); and
a polymer encapsulating the platinum(0) and/or platinum (II);
wherein the polymer comprises structural units, at least some of the structural units of the polymer include a pyridine moiety, and wherein at least some of the platinum(0) and/or platinum (II) is/are bound to at least some of the pyridine moieties of the polymer;
with the proviso that the encapsulated catalyst comprises at least 500 equivalents of pyridine moieties relative to total platinum content when the platinum is platinum(0).

2. The encapsulated catalyst of claim 1, wherein:
(i) the encapsulated catalyst comprises at least 750 equivalents of pyridine moieties relative to total platinum content;
(ii) at least 50 mol % of the structural units of the polymer include a pyridine moiety; or
(iii) both (i) and (ii).

3. The encapsulated catalyst of claim 1, wherein the structural units of the polymer that include a pyridine moiety are derived from 4-vinyl pyridine, and optionally wherein the polymer includes structural units derived from at least one monomer other than 4-vinyl pyridine.

4. The encapsulated catalyst of claim 3, wherein the polymer includes structural units derived from at least one monomer other than 4-vinyl pyridine, and wherein the at least one monomer is selected from a (meth)acrylate monomer, styrene, a (meth)acrylate-functional siloxane, or combinations thereof.

5. The encapsulated catalyst of claim 4, wherein the polymer includes structural units derived from the (meth)acrylate-functional siloxane, which has the following formula:

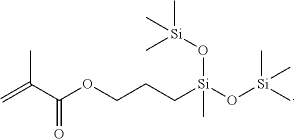

6. A method of preparing an encapsulated catalyst for hydrosilylation, said method comprising:
combining platinum(0) and/or platinum (II) with a polymer; and
encapsulating the platinum(0) and/or platinum (II) with the polymer;
wherein the polymer comprises structural units, at least some of the structural units of the polymer include a pyridine moiety, and wherein at least some of the platinum(0) and/or platinum (II) is/are bound to at least some of the pyridine moieties of the polymer;
with the proviso that the encapsulated catalyst comprises at least 500 equivalents of pyridine moieties relative to total platinum content when the platinum is platinum(0).

7. The method of claim 6, free from a step of washing the encapsulated catalyst prior to use in a hydrosilylation reaction.

8. The method of claim 6, wherein combining platinum(0) and/or platinum (II) with the polymer comprises combining a platinum(0) complex and/or platinum (II) complex with the polymer, and wherein at least some ligands of the platinum(0) complex and/or platinum (II) complex disassociate from the platinum(0) and/or platinum (II) during encapsulation by the polymer.

9. The method of claim 8, wherein:
(i) the platinum(0) complex has the following formula: 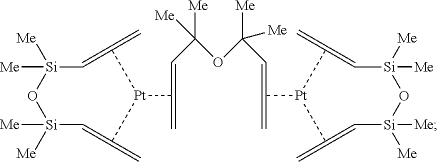
and
(ii) the platinum (II) complex has the following formula:

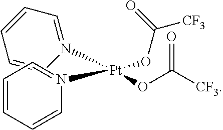

10. The method of claim 6, wherein:
(i) the encapsulated catalyst comprises at least 750 equivalents of pyridine moieties relative to total platinum content;
(ii) at least 50 mol % of the structural units of the polymer include a pyridine moiety; or
(iii) both (i) and (ii).

11. A composition, comprising:
(A) an unsaturated compound including at least one aliphatically unsaturated group per molecule, subject to at least one of the following two provisos:
(1) the unsaturated compound (A) also includes at least one silicon-bonded hydrogen atom per molecule; and/or
(2) the composition further comprises (B) a silicon hydride compound including at least one silicon-bonded hydrogen atom per molecule; and
(C) the encapsulated catalyst of claim 1.

12. The composition of claim 11, wherein proviso (2) is true such that the composition further comprises (B) the silicon hydride compound including at least one silicon-bonded hydrogen atom per molecule.

13. A method of preparing a hydrosilylation reaction product, said method comprising:
reacting an aliphatically unsaturated group and a silicon-bonded hydrogen atom in the presence of (C) an encapsulated catalyst to give the hydrosilylation reaction product;
wherein the aliphatically unsaturated group is present in (A) an unsaturated compound;
wherein at least one of the following two provisos applies:
(1) the unsaturated compound (A) also includes at least one silicon-bonded hydrogen atom per molecule; and/or
(2) the silicon-bonded hydrogen atom is present in (B) a silicon hydride compound separate from the unsaturated compound (A); and
wherein the encapsulated catalyst (C) comprises the encapsulated catalyst of claim 1.

14. A hydrosilylation reaction product formed in accordance with the method of claim 13.

15. A hydrosilylation-curable silicone composition or hydrosilylation reaction product comprising the encapsulated catalyst of claim 1.
